(19) United States
(12) Patent Application Publication
(10) Pub. No.: US 2023/0103101 A1
(43) Pub. Date: Mar. 30, 2023

(54) PRESSURE SENSITIVE TONER, APPARATUS FOR PRODUCING PRINTED MATERIAL, METHOD FOR PRODUCING PRINTED MATERIAL, AND PRINTED MATERIAL

(71) Applicant: FUJIFILM Business Innovation Corp., Tokyo (JP)

(72) Inventors: Takeshi IWANAGA, Kanagawa (JP); Takako KOBAYASHI, Kanagawa (JP); Mieko SEKI, Kanagawa (JP); Kiyohiro YAMANAKA, Kanagawa (JP); Satoshi KAMIWAKI, Kanagawa (JP)

(73) Assignee: FUJIFILM Business Innovation Corp., Tokyo (JP)

(21) Appl. No.: 17/862,855

(22) Filed: Jul. 12, 2022

(30) Foreign Application Priority Data
Sep. 24, 2021 (JP) 2021-156205

(51) Int. Cl. G03G 9/087; G03G 9/08; G03G 15/00

(52) U.S. Cl. CPC G03G 9/08711; G03G 9/08728; G03G 9/08797; G03G 9/08793; G03G 9/0819; G03G 15/6582

(57) ABSTRACT

A pressure sensitive toner includes toner particles containing a composite resin that includes a styrene-based resin and a (meth)acrylate-based resin. The difference between a lowest glass transition temperature of the composite resin and a highest glass transition temperature thereof is 30° C. or more, and the toner particles have a gel fraction of from 1.0% by mass to 8.0% by mass inclusive.

### CROSS-REFERENCE TO RELATED APPLICATIONS

This application is based on and claims priority under 35 USC 119 from Japanese Patent Application No. 2021-156205 filed Sep. 24, 2021.

### BACKGROUND

### (i) Technical Field

The present disclosure relates to a pressure sensitive toner, an apparatus for producing a printed material, a method for producing a printed material, and a printed material.

### (ii) Related Art

Japanese Unexamined Patent Application Publication No. 2021-018421 discloses pressure responsible particles containing: pressure responsible base particles containing a styrene-based resin that includes styrene and another vinyl monomer as polymerization components and a (meth)acrylate-based resin that includes at least two (meth)acrylates as polymerization components with the mass ratio of the (meth)acrylates with respect to the total mass of the polymerization components being 90% by mass or more; and an external additive containing titanium oxide particles. The pressure responsible particles have at least two glass transition temperatures, and the difference between the lowest glass transition temperature and the highest glass transition temperature is 30° C. or more.

Japanese Unexamined Patent Application Publication No. 2005-146151 discloses a pressure sensitive toner for a protective sheet. The pressure sensitive toner contains the following components (A), (B), and (C):

(A) a (meth)acrylic polymer prepared by copolymerizing at least an alkyl (meth)acrylate and a functional group-containing monomer and having a glass transition temperature of −40° C. or lower;

(B) a (meth)acrylic polymer containing an alkyl (meth)acrylate as a main component and having a glass transition temperature of 80° C. or higher; and

(C) a crosslinking agent.

The pressure sensitive toner is prepared by subjecting a crosslinkable composition containing 100 parts by weight of component (A) and 5 to 20 parts by weight of component (B) to a crosslinking reaction to a gel fraction of 80% or more.

### SUMMARY

Aspects of non-limiting embodiments of the present disclosure relate to a pressure sensitive toner including toner particles containing a composite resin that includes a styrene-based resin and a (meth)acrylate-based resin. In the pressure sensitive toner, the difference between a lowest glass transition temperature of the composite resin and a highest glass transition temperature thereof is 30° C. or more. The pressure sensitive toner has higher bonding power, better tear resistance during peeling, and better hot offset resistance than a pressure sensitive toner including toner particles with a gel fraction of less than 1.0% by mass or more than 8.0% by mass.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a pressure sensitive toner including toner particles containing a composite resin that includes a styrene-based resin and a (meth)acrylate-based resin, wherein the difference between a lowest glass transition temperature of the composite resin and a highest glass transition temperature thereof is 30° C. or more, and wherein the toner particles have a gel fraction of from 1.0% by mass to 8.0% by mass inclusive.

### BRIEF DESCRIPTION OF THE DRAWINGS

An exemplary embodiment of the present disclosure will be described in detail based on the following figures, wherein:

FIG. 1 is a schematic illustration showing an example of a printed material production apparatus in the present exemplary embodiment;

FIG. 2 is a schematic illustration showing another example of the printed material production apparatus in the present exemplary embodiment; and

FIG. 3 is a schematic illustration showing another example of the printed material production apparatus in the present exemplary embodiment.

### DETAILED DESCRIPTION

An exemplary embodiment of the disclosure will be described below. The following description and Examples are illustrative of the exemplary embodiment and are not intended to limit the scope of the exemplary embodiment.

In the exemplary embodiment, a numerical range represented using “to” means a range including the numerical values before and after the “to” as the minimum value and the maximum value, respectively.

In a set of numerical ranges expressed in a stepwise manner in the exemplary embodiment, the upper or lower limit in one numerical range may be replaced with the upper or lower limit in another numerical range in the set. Moreover, in a numerical range described in the exemplary embodiment, the upper or lower limit in the numerical range may be replaced with a value indicated in an Example.

In the exemplary embodiment, the term “step” is meant to include not only an independent step but also a step that is not clearly distinguished from other steps, so long as the prescribed purpose of the step can be achieved.

When the exemplary embodiment is explained with reference to the drawings, the structure of the exemplary embodiment is not limited to the structure shown in the drawings. In the drawings, the sizes of the components are conceptual, and the relative relations between the components are not limited to those shown in the drawings.

In the exemplary embodiment, any component may contain a plurality of materials corresponding to the component. In the exemplary embodiment, when reference is made to the amount of a component in a composition, if the composition contains a plurality of materials corresponding to the component, the amount means the total amount of the plurality of materials in the composition, unless otherwise specified.

In the exemplary embodiment, particles corresponding to a certain component may include a plurality of types of particles. When a plurality of types of particles corresponding to a certain component are present in a composition, the particle diameter of the component is the value for the mixture of the plurality of types of particles present in the composition, unless otherwise specified.

In the exemplary embodiment, the notation “(meth)acrylic” is meant to include “acrylic” and “methacrylic.”

In the exemplary embodiment, a “toner for electrostatic image development” may be referred to simply as a “toner,” and an “electrostatic image developer” may be referred to simply as a “developer.”

In the exemplary embodiment, a printed material formed by folding a recording medium and bonding together its surfaces facing each other or a printed material formed by stacking two or more recording mediums and bonding together their surfaces facing each other is referred to as a “pressure-bonded printed material.”

### <Pressure Sensitive Toner>

A pressure sensitive toner in the present exemplary embodiment includes toner particles containing a composite resin that includes a styrene-based resin and a (meth)acrylate-based resin. The difference between the lowest glass transition temperature of the composite resin and the highest glass transition temperature thereof is 30° C. or more, and the toner particles have a gel fraction of from 1.0% by mass to 8.0% by mass inclusive.

When a pressure sensitive toner is used to produce, for example, a pressure-bonded postcard using electrophotography, the components of the pressure sensitive toner may melt unevenly when fixed using a fixing device. In this case, when, for example, the postcard is mailed in a summer environment in recent years, the peelability of the recording medium may deteriorate, and this may cause the recording medium to tear.

In the pressure sensitive toner in the present exemplary embodiment, it can be inferred that, since the toner particles contain the composite resin including the styrene-based resin and the (meth)acrylate-based resin, good bonding power is obtained. Moreover, since the gel fraction of the toner particles is 8.0% by mass or less, bonding by the pressure sensitive toner is not excessively strong even in an extremely hot environment in summer, and the bonded surfaces can be peeled from each other. Therefore, peelability is improved, and the recording medium is prevented from tearing during peeling. Moreover, since the gel fraction of the toner particles is 1.0% by mass or more, control of the melt viscosity of the toner during fixation and prevention of hot offset can be achieved simultaneously.

The hot offset is a phenomenon in which the toner is melted excessively during fixation of a toner image and adheres to a fixing member.

The components, structure, and characteristics of the pressure sensitive toner in the present exemplary embodiment will next be described in detail. In the following description, the “styrene-based resin” means a “styrene-based resin containing, as a polymerization component, 50% by mass or more of a styrene-based monomer” unless otherwise specified, and the “(meth)acrylate-based resin” means a “(meth)acrylate-based resin containing, as a polymerization component, 50% by mass or more of a (meth)acrylate compound” unless otherwise specified.

A (meth)acrylic compound may be any compound having a (meth)acrylic group, and examples thereof include (meth)acrylate compounds, (meth)acrylamide compounds, (meth)acrylic acid, and (meth)acrylonitrile.

### -Melt Viscosity at 100° C.-

From the viewpoint of bonding power, tear resistance during peeling, and hot offset resistance, the pressure sensitive toner in the present exemplary embodiment has a melt viscosity at 100° C. of preferably from 4,000 Pa·s to 20,000 Pa·s inclusive, more preferably from 5,000 Pa·s to 18,000 Pa·s inclusive, still more preferably from 6,000 Pa·s to 16,000 Pa·s inclusive, and particularly preferably from 7,000 Pa·s to 14,000 Pa·s inclusive.

The melt viscosity of the toner is measured by the following method.

A Koka flow tester CFT-500 (manufactured by Shimadzu Corporation) is used to determine the viscosity at a temperature corresponding to one-half of the height between a flow start point to a flow completion point when 1 cm³ of a sample (the toner) is melted and caused to flow using a die with a pore diameter of 0.5 mm under the conditions of a pressing load of 0.98 MPa (10 Kg/cm²) and a heating rate of 1° C./minute.

### (Toner Particles)

The toner particles contain the composite resin that includes the styrene-based resin and the (meth)acrylate-based resin. The difference between the lowest glass transition temperature of the composite resin and the highest glass transition temperature thereof is 30° C. or more, and its gel fraction is from 1.0% by mass to 8.0% by mass inclusive.

The toner particles are preferably particles formed at least by fusing and coalescing the particles of the composite resin and more preferably particles formed by aggregating, fusing, and coalescing the particles of the composite resin.

### -Gel Fractions of Toner Particles and Composite Resin-

The gel fraction of the toner particles is from 1.0% by mass to 8.0% by mass inclusive. From the viewpoint of bonding power, tear resistance during peeling, and hot offset resistance, the gel fraction of the toner particles is preferably from 1.5% by mass to 6.0% by mass inclusive and more preferably from 2.0% by mass to 5.0% by mass inclusive.

By controlling the amount of the crosslinked structure in the composite resin, the amount of a chain transfer agent used, the amount of insoluble components such as a release agent, the amount of a flocculant used, etc., the gel fraction of the toner particles can be easily controlled.

From the viewpoint of bonding power, tear resistance during peeling, and hot offset resistance, the gel fraction of the composite resin is preferably from 0.1% by mass to 2% by mass inclusive, more preferably from 0.3% by mass to 2% by mass inclusive, and particularly preferably from 0.3% by mass to 1.5% by mass inclusive.

By controlling the amount of the crosslinked structure in the composite resin, the amount of the chain transfer agent used, etc., the gel fraction of the composite resin can be easily controlled.

From the viewpoint of bonding power, tear resistance during peeling, and hot offset resistance, the ratio Y/X of the gel fraction Y of the toner particles to the gel fraction X of the composite resin satisfies preferably 0.8 Y/X≤80, more preferably 1≤Y/X≤50, and particularly preferably 1.5≤Y/X≤20.

The gel fraction is measured as follows.

The gel fraction measurement is performed according to JIS K6796 (1998).

Specifically, the following method is used. The mass of a measurement sample (the toner particles, the composite resin, etc.) is measured and used as the mass before extraction with a solvent. Next, the measurement sample is immersed in tetrahydrofuran for 24 hours. Then the solvent is removed by filtration, and the residue is filtered and weighed. The mass measured is used as the mass after extraction. The gel fraction is computed using the following formula.

Formula:gel fraction(%)=100×(mass after extraction with solvent)/(mass before extraction with solvent)

When the pressure sensitive toner is an external additive-added toner, the toner, together with a solution mixture of ion exchanged water and a surfactant, is subjected to ultrasonic wave treatment for 20 minutes to remove the external additive, and then the surfactant is removed. The toner particles are dried and collected, and then the measurement is performed. The treatment for removing the external additive may be repeated until the external additive is fully removed.

### -Volume Average Particle Diameter of Toner Particles-

From the viewpoint of ease of handling of the toner particles, the volume average particle diameter (D50v) of the toner particles is preferably 4 μm or more, more preferably 5 μm or more, and still more preferably 6 μm or more. From the viewpoint of ease of phase transition of the toner particles as a whole under pressure, the volume average particle diameter is preferably 12 μm or less and more preferably 10 μm or less.

The volume average particle diameter (D50v) of the toner particles is measured using Coulter Multisizer II (manufactured by Beckman Coulter, Inc.) and an aperture having an aperture diameter of 100 μm. 0.5 mg to 50 mg of the toner particles are added to 2 mL of a 5% by mass aqueous sodium alkylbenzenesulfonate solution and dispersed therein. Then the mixture is mixed with 100 mL to 150 mL of an electrolyte (ISOTON-II manufactured by Beckman Coulter, Inc.), and the resulting mixture is subjected to dispersion treatment for 1 minute using an ultrasonic disperser. The dispersion obtained is used as a sample. The diameters of 50000 particles having diameters of from 2 μm to 60 μm inclusive in the sample are measured. The particle diameter at which the cumulative frequency cumulated from the small diameter side in the volume-based particle size distribution is 50% is defined as the volume average particle diameter (D50v).

### <<Composite Resin>>

The toner particles contain the composite resin including the styrene-based resin and the (meth)acrylate-based resin, and the difference between the lowest glass transition temperature of the composite resin and the highest glass transition temperature thereof is 30° C. or more.

The composite resin in the present exemplary embodiment may be an alloy-like resin in which the styrene-based resin and the (meth)acrylate-based resin are simply mixed together or a resin in which the styrene-based resin and the (meth)acrylate-based resin are bonded through chemical bonds (such as covalent bonds).

The composite resin may have the ability to undergo pressure-induced phase transition.

The “ability to undergo pressure-induced phase transition” means that the following formula 1 is satisfied.

10° C.≤T1−T2 Formula 1

In formula 1, T1 is the temperature when the viscosity is 10,000 Pa·s at a pressure of 1 MPa, and T2 is the temperature at which the viscosity is 10,000 Pas at a pressure of 10 MPa.

The temperatures T1 and T2 are determined by the following method.

A measurement material is pressed to prepare a pellet-like sample. The pellet-like sample is placed in a flow tester (CFT-500 manufactured by Shimadzu Corporation). The pressure applied is fixed at 1 MPa, and the viscosity at 1 MPa is measured versus the temperature. From the obtained graph of the viscosity, the temperature T1 at which the viscosity is 10,000 Pas at an applied pressure of 1 MPa is determined. The temperature T2 is determined using the same method as that for determining the temperature T1 except that the applied pressure is changed from 1 MPa to 10 MPa.

### -Crosslinking Agent-

The composite resin may be a resin having a crosslinked structure.

The crosslinked structure may be present in the styrene-based resin or may be present in the (meth)acrylate-based resin. From the viewpoint of bonding power, tear resistance during peeling, and hot offset resistance, the (meth)acrylate-based resin may have at least the crosslinked structure.

By controlling the amount of the crosslinked structure, the gel fraction of the composite resin can be easily controlled.

The crosslinked structure may be formed using a crosslinking agent during polymerization.

The crosslinking agent is preferably a bifunctional or higher functional ethylenically unsaturated compound, more preferably a bifunctional or higher functional (meth)acrylate or a bifunctional or higher functional styrene-based monomer, still more preferably a bifunctional or higher functional (meth)acrylate, and particularly preferably a di(meth)acrylate.

The functionality of the ethylenically unsaturated group in the crosslinking agent is preferably 2 to 6, more preferably 2 or 3, and particularly preferably 2.

Examples of the ethylenically unsaturated group include functional groups such as a vinyl group, an allyl group, a propargyl group, a butenyl group, an ethynyl group, a phenylethynyl group, a maleimide group, a nadimido group, and a (meth)acryloyl group. Of these, a (meth)acryloyl group may be selected in terms of reactivity.

The crosslinking agent used may be a bifunctional monomer having two ethylenically unsaturated groups.

Examples of the bifunctional monomer having two ethylenically unsaturated groups include aliphatic di(meth)acrylates and aromatic di(meth)acrylates.

The aliphatic di(meth)acrylate is a compound in which two hydrogen atoms in the aliphatic hydrocarbon are replaced with (meth)acryloyl groups.

The structure of the aliphatic di(meth)acrylate may be branched or linear and may include a cyclic structure.

The number of carbon atoms in the aliphatic di(meth)acrylate (excluding the number of carbon atoms in the (meth)acryloyl groups) is preferably from 3 to 20 inclusive, more preferably from 5 to 15 inclusive, and still more preferably from 8 to 12 inclusive.

Specific examples of the aliphatic di(meth)acrylate include ethylene glycol di(meth)acrylate, diethylene glycol di(meth)acrylate, triethylene glycol di(meth)acrylate, butanediol di(meth)acrylate, pentanediol di(meth)acrylate, hexanediol di(meth)acrylate, nonanediol di(meth)acrylate, decanediol di(meth)acrylate, 2,2-bis(4-(meth)acryloxypolyethoxypolypropoxyphenyl)propane, and bisphenol A diglycidyl ether di(meth)acrylate.

The aromatic di(meth)acrylate is a compound having an aromatic group and two (meth)acryloyl groups.

The structure of the aromatic di(meth)acrylate may be branched or linear and may include a cyclic structure.

The number of carbon atoms in the aromatic di(meth)acrylate (excluding the number of carbon atoms in the (meth)acryloyl groups) is preferably from 3 to 20 inclusive, more preferably from 5 to 15 inclusive, and still more preferably from 8 to 12 inclusive.

Examples of the bifunctional or higher functional styrene-based monomer include divinylbenzene.

Moreover, a trifunctional or higher functional monomer such as trimethylolpropane triacrylate may be used.

No particular limitation is imposed on the amount of the structural unit derived from the crosslinking agent in the composite resin so long as the gel fraction falls within the above-described range. In particular, the amount of the structural unit derived from the crosslinking agent in the composite resin with respect to the total mass of the composite resin is preferably 0.05% by mass to 1.00% by mass, more preferably 0.10% by mass to 0.65% by mass, and particularly preferably 0.15% by mass to 0.45% by mass.

No particular limitation is imposed on the amount of the crosslinking agent added at the time of polymerization. From the viewpoint of bonding power, tear resistance during peeling, and hot offset resistance, the ratio of the amount of the crosslinking agent added to the amount of the chain transfer agent (described later) added (the amount of the crosslinking agent added/the amount of the chain transfer agent added) is preferably from 0.1 to 2.0 inclusive, more preferably from 0.3 to 1.0 inclusive, and particularly preferably from 0.3 to 0.8 inclusive.

### -Chain Transfer Agent-

The toner particles may contain the chain transfer agent.

The composite resin may contain a resin polymerized in the presence of the chain transfer agent.

The composite resin may contain a structural unit derived from the chain transfer agent.

The chain transfer agent may be a thiol group-containing compound (thiol).

The chain transfer agent may be a thiol having a hydrocarbon group having 4 to 20 carbon atoms.

Examples of the hydrocarbon group included in the thiol include aliphatic hydrocarbon groups and aromatic hydrocarbon groups.

The hydrocarbon group included in the thiol may be an aliphatic hydrocarbon group.

The aliphatic hydrocarbon group may be branched or linear.

Specifically, the chain transfer agent is preferably hexylthiol, heptanethiol, octanethiol, nonanethiol, decanethiol, dodecanethiol, tetradecanethiol, hexadecanethiol, etc. and more preferably dodecanethiol.

No particular limitation is imposed on the amount of the structural unit derived from the chain transfer agent in the composite resin. The amount may be such that the preferred ratio of the amount of the crosslinking agent added to the amount of the chain transfer agent added is satisfied.

### -Styrene-Based Resin-

The styrene-based resin may contain styrene and an additional vinyl monomer as polymerization components.

From the viewpoint of preventing the composite resin with no pressure applied thereto from fluidizing, the mass percentage of styrene with respect to the total mass of the polymerization components of the styrene-based resin is preferably 60% by mass or more, more preferably 70% by mass or more, and still more preferably 75% by mass or more. From the viewpoint of allowing the composite resin particles formed to readily undergo pressure-induced phase transition, the mass percentage of the styrene is preferably 95% by mass or less, more preferably 90% by mass or less, and still more preferably 85% by mass or less.

Examples of the styrene-based monomer other than styrene include: vinylnaphthalene; alkyl-substituted styrenes such as α-methylstyrene, o-methylstyrene, m-methylstyrene, p-methylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, and p-n-dodecylstyrene; aryl-substituted styrenes such as p-phenylstyrene; alkoxy-substituted styrenes such as p-methoxystyrene; halogen-substituted styrenes such as p-chlorostyrene, 3,4-dichlorostyrene, p-fluorostyrene, and 2,5-difluorostyrene; and nitro-substituted styrenes such as m-nitrostyrene, o-nitrostyrene, and p-nitrostyrene. Any one of these styrene-based monomers may be used alone, or two or more of them may be used in combination.

The additional vinyl monomer may be an acrylic-based monomer. The acrylic-based monomer may be at least one acrylic-based monomer selected from the group consisting of (meth)acrylic acid and (meth)acrylates. Examples of the (meth)acrylates include alkyl (meth)acrylates, carboxy-substituted alkyl (meth)acrylates, hydroxy-substituted alkyl (meth)acrylates, alkoxy-substituted alkyl (meth)acrylates, and di(meth)acrylates. Any one of these acrylic-based monomers may be used alone, or two or more of them may be used in combination.

Examples of the alkyl (meth)acrylates include methyl (meth)acrylate, ethyl (meth)acrylate, propyl (meth)acrylate, isopropyl (meth)acrylate, n-butyl (meth)acrylate, isobutyl (meth)methacrylate, n-hexyl (meth)acrylate, 2-ethylhexyl (meth)acrylate, lauryl (meth)acrylate, stearyl (meth)acrylate, cyclohexyl (meth)acrylate, dicyclopentanyl (meth)acrylate, and isobornyl (meth)acrylate.

Examples of the carboxy-substituted alkyl (meth)acrylates include 2-carboxyethyl (meth)acrylate.

Examples of the hydroxy-substituted alkyl (meth)acrylates include 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate.

Examples of the alkoxy-substituted alkyl (meth)acrylates include 2-methoxyethyl (meth)acrylate.

Other examples of the (meth)acrylate include 2-(diethylamino)ethyl (meth)acrylate, benzyl (meth)acrylate, and methoxypolyethylene glycol (meth)acrylate.

Other examples of the additional vinyl monomer included in the styrene-based resin include, in addition to the styrene-based monomers and the acrylic-based monomers: (meth)acrylonitrile; vinyl ethers such as vinyl methyl ether and vinyl isobutyl ether; vinyl ketones such as vinyl methyl ketone, vinyl ethyl ketone, and vinyl isopropenyl ketone; and olefines such as isoprene, butene, and butadiene.

From the viewpoint of bonding power and tear resistance during peeling, the styrene-based resin contains, as the additional vinyl monomer, preferably a (meth)acrylate, more preferably an alkyl (meth)acrylate, still more preferably an alkyl (meth)acrylate having an alkyl group having 2 to 10 carbon atoms, yet more preferably an alkyl (meth)acrylate having an alkyl group having 4 to 8 carbon atoms, and particularly preferably at least one of n-butyl acrylate and 2-ethylhexyl acrylate. The styrene-based resin and the (meth)acrylate-based resin may include the same (meth)acrylate as a polymerization component.

From the viewpoint of preventing the composite resin with no pressure applied thereto from fluidizing, the mass percentage of the (meth)acrylate with respect to the total mass of the polymerization components of the styrene-based resin is preferably 40% by mass or less, more preferably 30% by mass or less, and still more preferably 25% by mass or less. From the viewpoint of allowing the composite resin formed to readily undergo pressure-induced phase transition, the mass percentage of the (meth)acrylate is preferably 5% by mass or more, more preferably 10% by mass or more, and still more preferably 15% by mass or more. The (meth)acrylate is preferably an alkyl (meth)acrylate, more preferably an alkyl (meth)acrylate having an alkyl group having 2 to 10 carbon atoms, and still more preferably an alkyl (meth)acrylate having an alkyl group having 4 to 8 carbon atoms.

Particularly preferably, the styrene-based resin includes at least one of n-butyl acrylate and 2-ethylhexyl acrylate as a polymerization component. From the viewpoint of preventing the composite resin with no pressure applied thereto from fluidizing, the total amount of n-butyl acrylate and 2-ethylhexyl acrylate with respect to the total mass of the polymerization components of the styrene-based resin is preferably 40% by mass or less, more preferably 30% by mass or less, and still more preferably 25% by mass or less. From the viewpoint of allowing the composite resin formed to readily undergo pressure-induced phase transition, the total amount of n-butyl acrylate and 2-ethylhexyl acrylate is preferably 5% by mass or more, more preferably 10% by mass or more, and still more preferably 15% by mass or more.

From the viewpoint of preventing the composite resin with no pressure applied thereto from fluidizing, the weight average molecular weight of the styrene-based resin is preferably 3,000 or more, more preferably 4,000 or more, and still more preferably 5,000 or more. From the viewpoint of allowing the composite resin formed to readily undergo pressure-induced phase transition, the weight average molecular weight of the styrene-based resin is preferably 50,000 or less, more preferably 45,000 or less, and still more preferably 40,000 or less.

The weight average molecular weight of the resin is measured by gel permeation chromatography (GPC). In the molecular weight measurement by GPC, a GPC apparatus HLC-8120GPC manufactured by TOSOH Corporation is used. A TSKgel Super HM-M (15 cm) column manufactured by TOSOH Corporation and a tetrahydrofuran solvent are used. The weight average molecular weight of the resin is computed using a molecular weight calibration curve produced using monodispersed polystyrene standard samples.

From the viewpoint of preventing the composite resin with no pressure applied thereto from fluidizing, the glass transition temperature of the styrene-based resin is preferably 30° C. or higher, more preferably 40° C. or higher, and still more preferably 50° C. or higher. From the viewpoint of allowing the composite resin particles formed to readily undergo pressure-induced phase transition, the glass transition temperature of the styrene-based resin is preferably 110° C. or lower, more preferably 100° C. or lower, and still more preferably 90° C. or lower.

In the present disclosure, the glass transition temperature of a resin is determined using a differential scanning calorimetry curve (DSC curve) obtained by differential scanning calorimetry (DSC). More specifically, the glass transition temperature of the resin is determined from “extrapolated glass transition onset temperature” described in glass transition temperature determination methods in “Testing methods for transition temperatures of plastics” in JIS K7121-1987.

The glass transition temperature of the resin is controlled by adjusting the types of polymerization components and their polymerization ratio. The higher the density of flexible units such as methylene groups, ethylene groups, and oxyethylene groups included in the main chain, the lower the glass transition temperature tends to be. The higher the density of rigid units such as aromatic rings and cyclohexane rings included in the main chain, the higher the glass transition temperature tends to be. The higher the density of aliphatic groups in a side chain, the lower the glass transition temperature tends to be.

From the viewpoint of preventing the composite resin particles with no pressure applied thereto from fluidizing, the mass percentage of the styrene-based resin with respect to the total mass of the composite resin particles is preferably 55% by mass or more, more preferably 60% by mass or more, and still more preferably 65% by mass or more. From the viewpoint of allowing the composite resin particles formed to readily undergo pressure-induced phase transition, the mass percentage of the styrene-based resin is preferably 80% by mass or less, more preferably 75% by mass or less, and still more preferably 70% by mass or less.

### -(Meth)Acrylate-Based Resin-

The (meth)acrylate-based resin contains a (meth)acrylate as a polymerization component and contains preferably an acrylate as a polymerization component.

The mass percentage of the (meth)acrylate with respect to the total mass of the polymerization components of the (meth)acrylate-based resin is, for example, 90% by mass or more, more preferably 95% by mass or more, still more preferably 98% by mass or more, and yet more preferably 100% by mass.

Examples of the (meth)acrylate include alkyl (meth)acrylates, carboxy-substituted alkyl (meth)acrylates, hydroxy-substituted alkyl (meth)acrylates, alkoxy-substituted alkyl (meth)acrylates, and di(meth)acrylates.

Examples of the alkyl (meth)acrylates include methyl (meth)acrylate, ethyl (meth)acrylate, propyl (meth)acrylate, isopropyl (meth)acrylate, n-butyl (meth)acrylate, isobutyl (meth)methacrylate, n-hexyl (meth)acrylate, 2-ethylhexyl (meth)acrylate, lauryl (meth)acrylate, stearyl (meth)acrylate, cyclohexyl (meth)acrylate, dicyclopentanyl (meth)acrylate, and isobornyl (meth)acrylate.

Examples of the carboxy-substituted alkyl (meth)acrylates include 2-carboxyethyl (meth)acrylate.

Examples of the hydroxy-substituted alkyl (meth)acrylates include 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate.

Examples of the alkoxy-substituted alkyl (meth)acrylates include 2-methoxyethyl (meth)acrylate.

Examples of the di(meth)acrylates include ethylene glycol di(meth)acrylate, diethylene glycol di(meth)acrylate, triethylene glycol di(meth)acrylate, butanediol di(meth)acrylate, pentanediol di(meth)acrylate, hexanediol di(meth)acrylate, nonanediol di(meth)acrylate, and decanediol di(meth)acrylate.

Other examples of the (meth)acrylates include 2-(diethylamino)ethyl (meth)acrylate, benzyl (meth)acrylate, and methoxypolyethylene glycol(meth)acrylate.

Any one of these (meth)acrylates may be used alone, or two or more of them may be used in combination.

From the viewpoint of allowing the composite resin particles formed to readily undergo pressure-induced phase transition and to exhibit good bonding power and from the viewpoint that the pressure sensitive toner obtained exhibits good bonding power and peelability even when used to bond thin paper sheets together and is less likely to contaminate a pressure bonding machine used to press-bond the thin paper sheets, the (meth)acrylate is preferably an alkyl (meth)acrylate, more preferably an alkyl (meth)acrylate having an alkyl group having 2 to 10 carbon atoms, still more preferably an alkyl (meth)acrylate having an alkyl group having 4 to 8 carbon atoms, and particularly preferably n-butyl acrylate or 2-ethylhexyl acrylate. From the viewpoint of allowing the composite resin particles formed to readily undergo pressure-induced phase transition, the styrene-based resin and the (meth)acrylate-based resin may include the same (meth)acrylate as a polymerization component.

From the viewpoint of allowing the composite resin particles formed to readily undergo pressure-induced phase transition and to exhibit good bonding power, the mass percentage of the alkyl (meth)acrylate with respect to the total mass of the polymerization components of the (meth)acrylate-based resin is preferably 90% by mass or more, more preferably 95% by mass or more, still more preferably 98% by mass or more, and yet more preferably 100% by mass. The alkyl (meth)acrylate in this case is preferably an alkyl (meth)acrylate having an alkyl group having 2 to 10 carbon atoms and more preferably an alkyl (meth)acrylate having an alkyl group having 4 to 8 carbon atoms.

The (meth)acrylate-based resin may contain at least two (meth)acrylates as polymerization components.

When the (meth)acrylate-based resin contains at least two (meth)acrylates as polymerization components, the mass ratio of two (meth)acrylates with the highest mass percentages among the at least two (meth)acrylates included as the polymerization components of the (meth)acrylate-based resin is preferably 80:20 to 20:80, more preferably 70:30 to 30:70, and still more preferably 60:40 to 40:60, from the viewpoint of bonding power, tear resistance during peeling, and hot offset resistance.

When the (meth)acrylate-based resin contains at least two (meth)acrylates as polymerization components, the two (meth)acrylates with the highest mass percentages among the at least two (meth)acrylates included as the polymerization components of the (meth)acrylate-based resin may each be an alkyl (meth)acrylate. The alkyl (meth)acrylate is preferably an alkyl (meth)acrylate having an alkyl group having 2 to 10 carbon atoms and more preferably an alkyl (meth)acrylate having an alkyl group having 4 to 8 carbon atoms.

When the (meth)acrylate-based resin contains at least two (meth)acrylates as polymerization components and the two (meth)acrylates with the highest mass percentages among the at least two (meth)acrylates included as the polymerization components of the (meth)acrylate-based resin are each an alkyl (meth)acrylate, the difference between the numbers of carbon atoms in the alkyl groups in the two alkyl (meth)acrylates is preferably from 1 to 4 inclusive, more preferably from 2 to 4 inclusive, and still more preferably 3 or 4, from the viewpoint of allowing the composite resin formed to readily undergo pressure-induced phase transition and to exhibit good bonding power.

From the viewpoint of allowing the composite resin formed to readily undergo pressure-induced phase transition and to exhibit good bonding power, the (meth)acrylate-based resin contains preferably n-butyl acrylate and 2-ethylhexyl acrylate as polymerization components. Particularly preferably, the two (meth)acrylates with the highest mass percentages among the at least two (meth)acrylates included as the polymerization components of the (meth)acrylate-based resin are n-butyl acrylate and 2-ethylhexyl acrylate. The total amount of n-butyl acrylate and 2-ethylhexyl acrylate with respect to the total mass of the polymerization components of the (meth)acrylate-based resin is preferably 90% by mass or more, more preferably 95% by mass or more, still more preferably 98% by mass or more, and yet more preferably 100% by mass.

The (meth)acrylate-based resin may contain an additional vinyl monomer other than the (meth)acrylates as a polymerization component. Examples of the additional vinyl monomer other that the (meth)acrylates include: (meth)acrylic acid; styrene; styrene-based monomers other than styrene; (meth)acrylonitrile; vinyl ethers such as vinyl methyl ether and vinyl isobutyl ether; vinyl ketones such as vinyl methyl ketone, vinyl ethyl ketone, and vinyl isopropenyl ketone; and olefins such as isoprene, butene, and butadiene. Any one of these vinyl monomers may be used alone, or two or more of them may be used in combination.

When the (meth)acrylate-based resin contains the additional vinyl monomer other than the (meth)acrylates as a polymerization component, the additional vinyl monomer other than the (meth)acrylates is preferably at least one of acrylic acid and methacrylic acid and more preferably acrylic acid.

From the viewpoint of preventing the composite resin with no pressure applied thereto from fluidizing, the weight average molecular weight of the (meth)acrylate-based resin is preferably 100000 or more, more preferably 120000 or more, and still more preferably 150000 or more. From the viewpoint of allowing the composite resin formed to readily undergo pressure-induced phase transition, the weight average molecular weight of the (meth)acrylate-based resin is preferably 250000 or less, more preferably 220000 or less, and still more preferably 200000 or less.

From the viewpoint of allowing the composite resin formed to readily undergo pressure-induced phase transition, the glass transition temperature of the (meth)acrylate-based resin is preferably 10° C. or lower, more preferably 0° C. or lower, and still more preferably −10° C. or lower. From the viewpoint of preventing the composite resin with no pressure applied thereto from fluidizing, the glass transition temperature of the (meth)acrylate-based resin is preferably −90° C. or higher, more preferably −80° C. or higher, and still more preferably −70° C. or higher.

From the viewpoint of allowing the composite resin formed to readily undergo pressure-induced phase transition, the mass percentage of the (meth)acrylate-based resin with respect to the total mass of the composite resin is preferably 20% by mass or more, more preferably 25% by mass or more, and still more preferably 30% by mass or more. From the viewpoint of preventing the composite resin with no pressure applied thereto from fluidizing, the mass percentage of the (meth)acrylate-based resin is preferably 45% by mass or less, more preferably 40% by mass or less, and still more preferably 35% by mass or less.

The total amount of the styrene-based resin and the (meth)acrylate-based resin contained in the composite resin with respect to the total mass of the composite resin is preferably 70% by mass or more, more preferably 80% by mass or more, still more preferably 90% by mass or more, yet more preferably 95% by mass or more, and particularly preferably 100% by mass.

### -Additional Resins-

The composite resin may optionally contain, for example, polystyrene and non-vinyl resins such as epoxy resins, polyester resins, polyurethane resins, polyamide resins, cellulose resins, polyether resins, and modified rosins. Any one of these resins may be used alone, or two or more of them may be used in combination.

### -Mass Ratio of Styrene-Based Resin to (Meth)Acrylate-Based Resin-

From the viewpoint of bonding power, tear resistance during peeling, and hot offset resistance, the mass ratio of the styrene-based resin to the (meth)acrylate-based resin (the styrene-based resin:the (meth)acrylate-based resin) is preferably 80:20 to 20:80, more preferably 75:25 to 25:75, still more preferably 70:30 to 30:70, and particularly preferably 65:35 to 35:65.

### -Glass Transition Temperatures-

The difference between the lowest glass transition temperature of the composite resin and its highest glass transition temperature is 30° C. or more.

When the composite resin having at least two glass transition temperatures contains the styrene-based resin and the (meth)acrylate-based resin, one of the glass transition temperatures may be the glass transition temperature of the styrene-based resin, and another one of the glass transition temperatures may be the glass transition temperature of the (meth)acrylate-based resin.

The composite resin may have three or more glass transition temperatures, but the number of glass transition temperatures is preferably 2. Examples of the composite resin having two glass transition temperatures include: a composite resin that contains only the styrene-based resin and the (meth)acrylate-based resin; and a composite resin that contains only a small amount of an additional resin other than the styrene-based resin and the (meth)acrylate-based resin (for example, the content of the additional resin with respect to the total mass of the composite resin is 5% by mass or less).

When the composite resin has at least two glass transition temperatures and the difference between the lowest glass transition temperature and the highest glass transition temperature is 30° C. or more, the difference between the lowest glass transition temperature and the highest glass transition temperature is preferably 40° C. or more, more preferably 50° C. or more, and still more preferably 60° C. or more, from the viewpoint of bonding power, tear resistance during peeling, and hot offset resistance. The upper limit of the difference between the lowest glass transition temperature and the highest glass transition temperature may be, for example, 140° C. or less, may be 130° C. or less, and may be 120° C. or less.

From the viewpoint of bonding power, tear resistance during peeling, and hot offset resistance, the lowest glass transition temperature of the composite resin is preferably 10° C. or lower, more preferably 0° C. or lower, and still more preferably −10° C. or lower. From the viewpoint of preventing the composite resin with no pressure applied thereto from fluidizing, the lowest glass transition temperature is preferably −90° C. or higher, more preferably −80° C. or higher, and still more preferably −70° C. or higher.

From the viewpoint of preventing the composite resin with no pressure applied thereto from fluidizing, the highest glass transition temperature of the composite resin is preferably 30° C. or higher, more preferably 40° C. or higher, and still more preferably 50° C. or higher. From the viewpoint of allowing the composite resin to readily undergo pressure-induced phase transition, the highest glass transition temperature is preferably 70° C. or lower, more preferably 65° C. or lower, and still more preferably 60° C. or lower.

The glass transition temperatures of the composite resin in the present exemplary embodiment are measured as follows.

The composite resin, the toner particles, or the pressure sensitive toner used as a measurement target is compressed to produce a plate-shaped sample. This sample is subjected to differential scanning calorimetry (DSC) to obtain a differential scanning calorimetry (DSC) curve, and the DSC curve is used to determine the glass transition temperatures. More specifically, the glass transition temperatures are determined from “extrapolated glass transition onset temperature” described in glass transition temperature determination methods in “Testing methods for transition temperatures of plastics” in JIS K7121-1987.

### -Weight Average Molecular Weight of Composite Resin-

From the viewpoint of bonding power, tear resistance during peeling, and hot offset resistance, the weight average molecular weight of the composite resin is preferably from 50000 to 500000 inclusive, more preferably from 80000 to 400000 inclusive, and still more preferably from 100000 to 350000 inclusive.

### -Content of Composite Resin-

From the viewpoint of bonding power, tear resistance during peeling, and hot offset resistance, the content of the composite resin in the toner particles with respect to the total mass of the toner particles is preferably from 20% by mass to 95% by mass inclusive, more preferably from 50% by mass to 90% by mass inclusive, and still more preferably from 65% by mass to 90% by mass inclusive.

### <<Release Agent>>

The toner particles may further contain a release agent.

In the pressure sensitive toner in the present exemplary embodiment, the gel fraction of the toner particles may be controlled by changing the type of release agent and its content.

Examples of the release agent include: hydrocarbon-based waxes; natural waxes such as carnauba wax, rice wax, and candelilla wax; synthetic and mineral/petroleum-based waxes such as montan wax; and ester-based waxes such as fatty acid esters and montanic acid esters. However, the release agent is not limited to them.

The melting temperature of the release agent is preferably from 50° C. to 110° C. inclusive and more preferably from 60° C. to 100° C. inclusive.

The melting temperature is determined using a differential scanning calorimetry (DSC) curve obtained by DSC from “peak melting temperature” described in melting temperature determination methods in “Testing methods for transition temperatures of plastics” in JIS K7121-1987.

From the viewpoint of bonding power, tear resistance during peeling, and hot offset resistance, the content of the release agent with respect to the total mass of the toner particles is preferably from 0.1% by mass to 8.0% by mass inclusive, more preferably 0.2% by mass to 5.0% by mass inclusive, and particularly preferably 0.3% by mass to 3.0% by mass inclusive.

### <<Coloring Agent>>

The toner particles may contain a coloring agent.

Examples of the coloring agent include: various pigments such as carbon black, chrome yellow, hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, DuPont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and various dyes such as acridine-based dyes, xanthene-based dyes, azo-based dyes, benzoquinone-based dyes, azine-based dyes, anthraquinone-based dyes, thioindigo-based dyes, dioxazine-based dyes, thiazine-based dyes, azomethine-based dyes, indigo-based dyes, phthalocyanine-based dyes, aniline black-based dyes, polymethine-based dyes, triphenylmethane-based dyes, diphenylmethane-based dyes, and thiazole-based dyes.

Any one of these coloring agents may be used alone, or two or more of them may be used in combination.

The coloring agent used may be optionally subjected to surface treatment or may be used in combination with a dispersant. A plurality of coloring agents may be used in combination.

The content of the coloring agent based on the total mass of the toner particles is preferably from 0.01% by mass to 30% by mass inclusive and more preferably from 0.1% by mass to 15% by mass inclusive.

### -Additional Additives-

Examples of additional additives include well-known additives such as a magnetic material, a charge control agent, and an inorganic powder. These additives are contained in the toner particles as internal additives.

-Characteristics Etc. Of Toner Particles-

The toner particles may have a single layer structure or may have a so-called core-shell structure including a core (core particle) and a coating layer (shell layer) covering the core.

Toner particles having the core-shell structure may each include, for example: a core containing a binder resin and optional additives such as a coloring agent and a release agent; and a coating layer containing a binder resin.

Examples of the optional additives include well-known additives such as a magnetic material, a charge control agent, and an inorganic powder. These additives are contained in the toner particles as internal additives.

### (External Additives)

The pressure sensitive toner in the present exemplary embodiment contains at least the toner particles and optionally contains external additives.

Examples of the external additives include inorganic particles. Examples of the inorganic particles include particles of SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, and MgSO₄.

The surfaces of the inorganic particles used as the external additive may be subjected to hydrophobic treatment. The hydrophobic treatment is performed, for example, by immersing the inorganic particles in a hydrophobic treatment agent. No particular limitation is imposed on the hydrophobic treatment agent. Examples of the hydrophobic treatment agent include silane-based coupling agents, silicone oils, titanate-based coupling agents, and aluminum-based coupling agents. These may be used alone or in combination of two or more.

The amount of the hydrophobic treatment agent is generally, for example, from 1 part by mass to 10 parts by mass inclusive based on 100 parts by mass of the inorganic particles.

Other examples of the external additive include resin particles (particles of resins such as polystyrene, polymethyl methacrylate (PMMA), and melamine resin) and cleaning activators (such as a metal salt of a higher fatty acid typified by zinc stearate and particles of a fluorine-based high-molecular weight material).

The amount of the external additive to be added externally with respect to the total mass of the toner particles is, for example, preferably from 0.01% by mass to 10% by mass inclusive and more preferably from 0.01% by mass to 5.0% by mass or less inclusive.

### (Method for Producing Pressure Sensitive Toner)

No particular limitation is imposed on the method for producing the pressure sensitive toner in the present exemplary embodiment. The method may include:

a first step of preparing a styrene-based resin particle dispersion containing dispersed therein styrene-based resin particles containing the styrene-based resin;

a second step of polymerizing the (meth)acrylate-based resin in a reaction solution containing the styrene-based resin particle dispersion, the chain transfer agent, the crosslinking agent, and the polymerization components of the (meth)acrylate-based resin to thereby form composite resin particles containing the styrene-based resin and the (meth)acrylate-based resin;

a third step of aggregating the composite resin particles in the composite resin particle dispersion containing the composite resin particles dispersed therein; and

a fourth step of heating the aggregated particle dispersion containing the aggregated particles dispersed therein to fuse/coalesce the aggregated particles to thereby form toner particles.

The details of the above steps will be described.

In the following, a method for obtaining toner particles containing no coloring agent and no release agent will be described. A coloring agent, a release agent, and other additives may be optionally used. When the toner particles contain a coloring agent and a release agent, the composite resin particle dispersion, a coloring agent particle dispersion, and a release agent particle dispersion are mixed, and then the fourth step is performed. The coloring agent particle dispersion and the release agent particle dispersion are each produced, for example, by mixing materials and subjecting the mixture to dispersion treatment using a well-known dispersing device.

### -First Step-

The first step is the step of preparing the styrene-based resin particle dispersion containing dispersed therein the styrene-based resin particles containing the styrene-based resin.

The styrene-based resin particle dispersion is, for example, a dispersion prepared by dispersing the styrene-based resin particles in a dispersion medium using a surfactant.

The dispersion medium may be a water-based medium.

Examples of the surfactant include: anionic surfactants such as sulfate-based surfactants, sulfonate-based surfactants, phosphate-based surfactants, and soap-based surfactants; cationic surfactants such as amine salt-based surfactants and quaternary ammonium salt-based surfactants; and nonionic surfactants such as polyethylene glycol-based surfactants, alkylphenol ethylene oxide adduct-based surfactants, and polyhydric alcohol-based surfactants. A nonionic surfactant may be used in combination with an anionic surfactant or a cationic surfactant. Among the above surfactants, anionic surfactants may be used. Any of the above surfactants may be used alone, or two or more of them may be used in combination.

Examples of the method for dispersing the styrene-based resin particles in the dispersion medium include a method including mixing the styrene-based resin and the dispersion medium and stirring the mixture using a rotary shearing-type homogenizer, a ball mill using media, a sand mill, or a dyno-mill to disperse the styrene-based resin particles.

Another method for dispersing the styrene-based resin particles in the dispersion medium is an emulsion polymerization method. Specifically, the polymerization components of the styrene-based resin and a chain transfer agent or a polymerization initiator are mixed, and a water-based medium containing the surfactant is further mixed. The mixture is stirred to produce an emulsion, and the styrene-based resin is polymerized in the emulsion. In this case, the chain transfer agent used may be dodecanethiol.

The volume average particle diameter of the styrene-based resin particles dispersed in the styrene-based resin particle dispersion is preferably from 100 nm to 250 nm inclusive, more preferably from 120 nm to 220 nm inclusive, and still more preferably from 150 nm to 200 nm inclusive.

The volume average particle diameter of the resin particles contained in the resin particle dispersion is determined as follows. The diameters of the particles are measured using a laser diffraction particle size distribution measurement apparatus (e.g., LA-700 manufactured by HORIBA Ltd.), and the particle diameter at which the cumulative frequency in the volume-based particle size distribution computed from the small-diameter side is 50% is defined as the volume average particle diameter (D50v).

The content of the styrene-based resin particles contained in the styrene-based resin particle dispersion is preferably from 30% by mass to 60% by mass inclusive and more preferably from 40% by mass to 50% by mass inclusive.

### -Second Step-

The second step is the step of polymerizing the (meth)acrylate-based resin in the reaction solution containing the styrene-based resin particle dispersion, the chain transfer agent, the crosslinking agent, and the polymerization components of the (meth)acrylate-based resin to thereby form the composite resin particles.

The composite resin particles may be resin particles containing the styrene-based resin and the (meth)acrylate-based resin that are microscopically phase-separated. These resin particles are produced, for example, by the following method.

The chain transfer agent, the crosslinking agent, and the polymerization components of the (meth)acrylate-based resin are added to the styrene-based resin particle dispersion, and a water-based medium is optionally added. Next, while the dispersion is slowly stirred, the temperature of the dispersion is increased to a temperature equal to or higher than the glass transition temperature of the styrene-based resin (for example, a temperature higher by 10° C. to 30° C. than the glass transition temperature of the styrene-based resin). Next, while the temperature is maintained, a water-based medium containing a polymerization initiator is slowly added dropwise, and the mixture is continuously stirred for a long time in the range of from 1 hour to 15 hours inclusive. In this case, ammonium persulfate may be used as the polymerization initiator.

It is inferred that, when the above method is used, the styrene-based resin particles are impregnated with the monomers and the polymerization initiator and the (meth)acrylate-based resin is polymerized inside the styrene-based resin particles, although the detailed mechanism of this process is unclear. In this case, the (meth)acrylate-based resin is contained in the styrene-based resin particles. It is inferred that, in the composite resin particles obtained, the styrene-based resin and the (meth)acrylate-based resin are microscopically phase-separated.

The volume average particle diameter of the composite resin particles dispersed in the composite resin particle dispersion is preferably from 140 nm to 300 nm inclusive, more preferably from 150 nm to 280 nm inclusive, and still more preferably from 160 nm to 250 nm inclusive.

The volume average particle diameter of the composite resin particles is determined as follows. The diameters of the particles are measured using a laser diffraction particle size distribution measurement apparatus (e.g., LA-700 manufactured by HORIBA Ltd.), and the particle diameter at which the cumulative frequency in the volume-based particle size distribution computed from the small-diameter side is 50% is defined as the volume average particle diameter (D50v).

The content of the composite resin particles contained in the composite resin particle dispersion is preferably from 20% by mass to 50% by mass inclusive and more preferably from 30% by mass to 40% by mass inclusive.

### -Third Step-

The third step is the step of aggregating the composite resin particles in the composite resin particle dispersion containing the composite resin particles dispersed therein to form aggregated particles.

The composite resin particles are aggregated in the composite resin particle dispersion to form aggregated particles having diameters close to the target diameter of the toner particles.

Specifically, for example, a flocculant is added to the composite resin particle dispersion, and the pH of the composite resin particle dispersion is adjusted to acidic (for example, a pH of from 2 to 5 inclusive). Then a dispersion stabilizer is optionally added, and the resulting mixture is heated to a temperature close to the glass transition temperature of the styrene-based resin (specifically, for example, a temperature from the glass transition temperature of the styrene-based resin −30° C. to the glass transition temperature −10° C. inclusive) to aggregate the composite resin particles to thereby form aggregated particles.

In the aggregated particle forming step, the flocculant may be added at room temperature (e.g., 25° C.) while the composite resin particle dispersion is stirred, for example, in a rotary shearing-type homogenizer. Then the pH of the composite resin particle dispersion may be adjusted to acidic (e.g., a pH of from 2 to 5 inclusive), and the dispersion stabilizer may be optionally added. Then the resulting mixture may be heated.

Examples of the flocculant include a surfactant with a polarity opposite to the polarity of the surfactant contained in the composite resin particle dispersion, inorganic metal salts, and divalent and higher polyvalent metal complexes. When a metal complex is used as the flocculant, the amount of the surfactant used is small, and charging characteristics are improved.

An additive that forms a complex with a metal ion in the flocculant or a similar bond may be used in combination with the flocculant. The additive used may be a chelating agent.

Examples of the inorganic metal salts include: metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

The chelating agent used may be a water-soluble chelating agent. Examples of the chelating agent include: oxycarboxylic acids such as tartaric acid, citric acid, and gluconic acid; and aminocarboxylic acids such as iminodiacetic acid (IDA), nitrilotriacetic acid (NTA), and ethylenediaminetetraacetic acid (EDTA).

The amount of the chelating agent added is preferably from 0.01 parts by mass to 5.0 parts by mass inclusive and more preferably 0.1 parts by mass or more and less than 3.0 parts by mass based on 100 parts by mass of the resin particles.

### -Fourth Step-

The fourth step is the step of heating the aggregated particle dispersion containing the aggregated particles dispersed therein to fuse and coalesce the aggregated particles to thereby form the toner particles.

The aggregated particle dispersion containing the aggregated particles dispersed therein is heated to, for example, a temperature equal to or higher than the glass transition temperature of the styrene-based resin (for example, a temperature higher by 10° C. to 30° C. than the glass transition temperature of the styrene-based resin) to fuse and coalesce the aggregated particles to thereby form the toner particles.

The toner particles obtained through the above steps generally have a sea-island structure including a sea phase containing the styrene-based resin and an island phase dispersed in the sea phase and containing the (meth)acrylate-based resin. In the composite resin particles, the styrene-based resin and the (meth)acrylate-based resin are microscopically phase-separated. However, in the fusion/coalescence step, it is inferred that styrene-based resin domains coalesce and form the sea phase and (meth)acrylate-based resin domains coalesce and form the island phase.

Toner particles having the core-shell structure are produced, for example, through the steps of:

after the aggregated particle dispersion has been obtained, further mixing the aggregated particle dispersion with the styrene-based resin particle dispersion to aggregate these particles such that the styrene-based resin particles further adhere to the surface of the aggregated particles to thereby form second aggregated particles; and

heating the second aggregated particle dispersion containing the second aggregated particles dispersed therein to fuse and coalesce the second aggregated particles to thereby form the toner particles having the core-shell structure.

The toner particles obtained through the above steps have the core-shell structure including the shell layer containing the styrene-based resin. Instead of the styrene-based resin particle dispersion, a resin particle dispersion containing other resin particles dispersed therein may be used to form a shell layer containing the other resin.

After completion of the fusion/coalescence step, the toner particles formed in the solution are subjected to a well-known washing step, a solid-liquid separation step, and a drying step to obtain dried toner particles. From the viewpoint of chargeability, the toner particles may be subjected to displacement washing with ion exchanged water sufficiently in the washing step. From the viewpoint of productivity, suction filtration, pressure filtration, etc. may be performed in the solid-liquid separation step. From the viewpoint of productivity, freeze-drying, flash drying, fluidized drying, vibrating fluidized drying, etc. may be performed in the drying step.

The toner is produced, for example, by adding the external additive to the dried toner particles obtained and mixing them. The mixing may be performed, for example, using a V blender, a Henschel mixer, a Loedige mixer, etc. If necessary, coarse particles in the toner may be removed using a vibrating sieving machine, an air sieving machine, etc.

### <Cartridge>

A cartridge in the present exemplary embodiment houses the pressure sensitive toner in the present exemplary embodiment and is detachably attached to a printed material production apparatus. When the cartridge is attached to the printed material production apparatus, the cartridge and a placing device included in the printed material production apparatus and used to place the pressure sensitive toner on a recording medium are connected through a supply tube.

The pressure sensitive toner is supplied from the cartridge to the placing device, and the cartridge is replaced when the cartridge runs out of the pressure sensitive toner.

### <Printed Material Production Apparatus, Method for Producing Printed Material, and Printed Material>

A printed material production apparatus in the present exemplary embodiment includes: a placing device that houses the pressure sensitive toner in the present exemplary embodiment and places the pressure sensitive toner on a recording medium; and a pressure-bonding device that folds the recording medium and press-bonds the folded recording medium or that press-bonds the recording medium and an additional recording medium stacked together.

A printed material in the present exemplary embodiment may be any printed material bonded using the pressure sensitive toner in the present exemplary embodiment.

Examples of the printed material in the present exemplary embodiment include: a printed material in which the opposed surfaces of panels of a folded recording medium are bonded with the pressure sensitive toner in the present exemplary embodiment; and a printed material in which opposed surfaces of a plurality of stacked recording mediums are bonded with the pressure sensitive toner in the present exemplary embodiment.

The placing device includes, for example, an application unit that applies the pressure sensitive toner to a recording medium and may further include a fixing unit that fixes, to the recording medium, the pressure sensitive toner applied to the recording medium.

The pressure-bonding device includes, for example: a folding unit that folds the recording medium with the pressure sensitive toner placed thereon or a stacking unit that stacks the recording medium with the pressure sensitive toner placed thereon and an additional recording medium together; and a pressurizing unit that pressurizes the folded recording medium or the stacked recording mediums.

The pressurizing unit included in the pressure-bonding device applies pressure to the recording medium with the pressure sensitive toner placed thereon. The pressure sensitive toner on the recording medium is thereby fluidized and exerts its bonding power.

The printed material production apparatus in the present exemplary embodiment performs a printed material production method in the present exemplary embodiment. The printed material production method in the present exemplary embodiment includes the steps of: placing the pressure sensitive toner in the present exemplary embodiment on a recording medium; and folding the recording medium and then pressure-bonding the folded recording medium or stacking the recording medium and an additional recording medium together and then pressure-bonding the stacked recording mediums.

The placing step includes, for example, the step of applying the pressure sensitive toner to a recording medium and may further include the step of fixing, to the recording medium, the pressure sensitive toner applied to the recording medium.

The pressure-bonding step includes, for example: a folding step of folding the recording medium or stacking the recording medium and an additional recording medium together; and a pressurizing step of pressurizing the folded recording medium or the stacked recording mediums.

The pressure sensitive toner may be placed over the entire recording medium or may be placed on part of the recording medium. A single layer or a plurality of layers of the pressure sensitive toner are placed on the recording medium. Each layer of the pressure sensitive toner may be a layer extending continuously in in-plane directions of the recording medium or may be a layer extending discontinuously in the in-plane directions of the recording medium. The layer of the pressure sensitive toner may be such that the pressure sensitive toner particles themselves are arranged or the pressure sensitive toner particles are arranged with adjacent pressure sensitive toner particles fused together.

The amount of the pressure sensitive toner (which may be transparent) on the placement region of the recording medium is, for example, from 0.5 g/m² to 50 g/m² inclusive, from 1 g/m² to 40 g/m² inclusive, and from 1.5 g/m² to 30 g/m² inclusive. The layer thickness of the pressure sensitive toner (which may be transparent) on the recording medium is, for example, from 0.2 μm to 25 μm inclusive, from 0.4 μm to 20 μm inclusive, and from 0.6 μm to 15 μm inclusive.

Examples of the recording medium used for the printed material production apparatus in the present exemplary embodiment include paper sheets, coated paper sheets obtained by coating paper sheets with resins etc., fabrics, nonwoven fabrics, resin films, and resin sheets. The recording medium may have an image on one side or both sides.

An example of the printed material production apparatus in the present exemplary embodiment will be shown, but the present exemplary embodiment is not limited thereto.

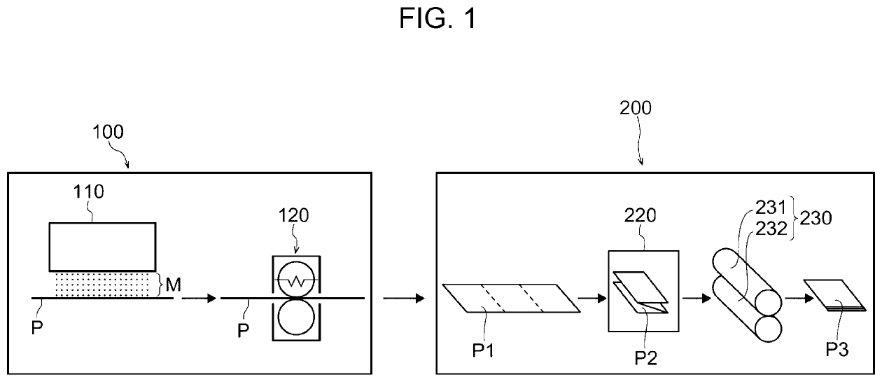

FIG. 1 is a schematic illustration showing an example of the printed material production apparatus in the present exemplary embodiment. The printed material production apparatus shown in FIG. 1 includes a placing device 100 and a pressure-bonding device 200 disposed downstream of the placing device 100. Arrows indicate a conveying direction of a recording medium.

The placing device 100 is a device that uses the pressure sensitive toner in the present exemplary embodiment and places the pressure sensitive toner on a recording medium P. The recording medium P has an image formed in advance on one side or both sides.

The placing device 100 includes an application unit 110 and a fixing unit 120 disposed downstream of the application unit 110.

The application unit 110 applies the pressure sensitive toner M to the recording medium P. Examples of the application method used in the application unit 110 include a spraying method, a bar coating method, a die coating method, a knife coating method, a roller coating method, a reverse roller coating method, a gravure coating method, a screen printing method, an inkjet method, a laminating method, and an electrophotographic method. In some application methods, the pressure sensitive toner M may be dispersed in a dispersion medium to prepare a liquid composition, and the liquid composition may be used for the application unit 110.

The recording medium P with the pressure sensitive toner M applied thereto in the application unit 110 is conveyed to the fixing unit 120.

The fixing unit 120 is, for example: a heating unit that includes a heat source and heats the pressure sensitive toner M on the recording medium P passing therethrough to fix the pressure sensitive toner M onto the recording medium P; a pressurizing unit that includes a pair of pressurizing members (roller/roller or belt/roller) and pressurizes the recording medium P passing therethrough to fix the pressure sensitive toner M onto the recording medium P; a pressurizing-heating unit that includes a pair of pressurizing members (roller/roller or belt/roller) including a built-in heat source and pressurizes and heats the recording medium P passing therethrough to fix the pressure sensitive toner M onto the recording medium P; etc.

When the fixing unit 120 includes a heat source, the surface temperature of the recording medium P heated by the fixing unit 120 is preferably from 10° C. to 80° C. inclusive, more preferably from 20° C. to 60° C. inclusive, and still more preferably from 30° C. to 50° C. inclusive.

When the fixing unit 120 includes a pressurizing member, the pressure applied by the pressurizing member to the recording medium P may be smaller than the pressure applied by a pressurizing unit 230 to the recording medium P2.

The recording medium P passes through the placing device 100 and thereby becomes a recording medium P1 with the pressure sensitive toner M applied to the image. The recording medium P1 is conveyed to the pressure-bonding device 200.

In the printed material production apparatus in the present exemplary embodiment, the placing device 100 and the pressure-bonding device 200 may be disposed close to each other or may be spaced apart from each other. When the placing device 100 and the pressure-bonding device 200 are spaced apart from each other, the placing device 100 is connected to the pressure-bonding device 200 through, for example, conveying means (e.g., a belt conveyer) for conveying the recording medium P1.

The pressure-bonding device 200 includes a folding unit 220 and the pressurizing unit 230 and is a device that folds and press-bonds the recording medium P1.

The folding unit 220 folds the recording medium P1 passing therethrough to produce a folded recording medium P2. Examples of the mode of folding of the recording medium P2 include a half fold, a trifold, and a quarter fold, and the recording medium P may overlap itself only partially. In any of these states, the pressure sensitive toner M is disposed on at least part of at least one of two opposed surfaces of panels of the folded recording medium P2.

The folding unit 220 may include a pair of pressurizing members (e.g., roller/roller or belt/roller) for applying pressure to the recording medium P2. The pressure applied by the pressurizing members of the folding unit 220 to the recording medium P2 may be smaller than the pressure applied by the pressurizing unit 230 to the recording medium P2.

The pressure-bonding device 200 may include, instead of the folding unit 220, a stacking unit that stacks the recording medium P1 and an additional recording medium together. Examples of the mode of stacking of the recording medium P1 and the additional recording medium include: a mode in which one additional recording medium is stacked on the recording medium P1; and a mode in which a plurality of additional recording mediums are stacked on respective regions of the recording medium P1. Each additional recording medium may be a recording medium having an image formed in advance on one side or both sides, may be a recording medium having no image formed thereon, or may be a pressure-bonded printed material produced in advance.

The recording medium P2 outputted from the folding unit 220 (or the stacking unit) is conveyed to the pressurizing unit 230.

The pressurizing unit 230 includes, for example, a pair of pressurizing members (i.e., pressurizing rollers 231 and 232). The pressurizing rollers 231 and 232 are in contact with each other at their outer circumferential surfaces, pressed against each other, and apply pressure to the recording medium P2 passing therethrough. The pair of pressurizing members included in the pressurizing unit 230 is not limited to the combination of the pressurizing rollers and may be a combination of a pressurizing roller and a pressurizing belt or a combination of pressurizing belts.

When pressure is applied to the recording medium P2 passing through the pressurizing unit 230, the pressure sensitive toner M on the recording medium P2 is fluidized by the pressure and exerts its bonding power.

The pressurizing unit 230 may or may not include a built-in heat source (e.g., a halogen heater) for heating the recording medium P2. The pressurizing unit 230 may not include the built-in heat source, but this does not exclude that the temperature inside the pressurizing unit 230 increases to a temperature equal to or higher than the temperature of the environment due to heat from, for example, a motor included in the pressurizing unit 230.

When the recording medium P2 passes through the pressurizing unit 230, the contacting surfaces of the folded recording medium P2 are bonded through the fluidized pressure sensitive toner M, and a pressure-bonded printed material P3 is thereby produced. In the pressure-bonded printed material P3, the two opposed surfaces are partly or entirely bonded to each other.

The completed pressure-bonded printed material P3 is discharged from the pressurizing unit 230.

A first form of the pressure-bonded printed material P3 is a pressure-bonded printed material in which the opposed surfaces of panels of the folded recording medium are bonded through the pressure sensitive toner M. The pressure-bonded printed material P3 in this form is produced using the printed material production apparatus including the folding unit 220.

A second form of the pressure-bonded printed material P3 is a pressure-bonded printed material in which opposed surfaces of a plurality of stacked recording mediums are bonded through the pressure sensitive toner M. The pressure-bonded printed material P3 in this form is produced using a pressure-bonded printed material production apparatus including the stacking unit.

The printed material production apparatus in the present exemplary embodiment is not limited to a device of the type in which recording mediums P2 are continuously conveyed from the folding unit 220 (or the stacking unit) to the pressurizing unit 230. The printed material production apparatus in the present exemplary embodiment may be a device of the type in which recording mediums P2 discharged from the folding unit 220 (or the stacking unit) are accumulated and then conveyed to the pressurizing unit 230 when the number of accumulated recording mediums P2 reaches a predetermined number.

In the printed material production apparatus in the present exemplary embodiment, the folding unit 220 (or the stacking unit) and the pressurizing unit 230 may be disposed close to each other or may be spaced apart from each other. When the folding unit 220 (or the stacking unit) is spaced apart from the pressurizing unit 230, the folding unit 220 (or the stacking unit) may be connected to the pressurizing unit 230 through, for example, conveying means (e.g., a belt conveyer) for conveying the recording medium P2.

The printed material production apparatus in the present exemplary embodiment may further include cutting means for cutting a recording medium into a predetermined size. Examples of the cutting means include: cutting means that is disposed between the placing device 100 and the pressure-bonding device 200 and cuts off a portion of the recording medium P1 on which no pressure sensitive toner M is disposed; cutting means that is disposed between the folding unit 220 and the pressurizing unit 230 and cuts off a portion of the recording medium P2 on which no pressure sensitive toner M is disposed; and cutting means that is disposed downstream of the pressure-bonding device 200 and cuts off a portion of the pressure-bonded printed material P3 that is not bonded with the pressure sensitive toner M.

The printed material production apparatus in the present exemplary embodiment is not limited to a sheet fed-type device. The printed material production apparatus in the present exemplary embodiment may be a device of the type in which a long recording medium is subjected to the placing step and the pressure-bonding step to form a long pressure-bonded printed material and then the long pressure-bonded printed material is cut into a predetermined size.

The printed material production apparatus in the present exemplary embodiment may further include color image forming means for forming a color image on a recording medium using coloring materials. Examples of the color image forming means include: means for forming a color ink image on a recording medium using color inks as the coloring materials by an inkjet method; and means for forming a color image on a recording medium using color electrostatic image developers by electrophotography.

The production apparatus having the above-described structure is used to perform the printed material production method in the present exemplary embodiment. In this case, the printed material production method further includes a color image forming step of forming a color image on a recording medium using a coloring material. Specific examples of the color image forming step include: the step of forming a color ink image on a recording medium using a color ink as the coloring material by an inkjet method; and the step of forming a color image on a recording medium using a color electrostatic image developer by electrophotography.

### <Production of Printed Material by Electrophotography>

An example in which the pressure sensitive toner in the present exemplary embodiment is applied to electrophotography will be described.

### -Electrostatic Image Developer-

An electrostatic image developer in the present exemplary embodiment contains at least the pressure sensitive toner in the present exemplary embodiment. The electrostatic image developer in the present exemplary embodiment may be a one-component developer containing only the pressure sensitive toner in the present exemplary embodiment or may be a two-component developer containing a mixture of the pressure sensitive toner in the present exemplary embodiment and a carrier.

No particular limitation is imposed on the carrier, and any well-known carrier may be used. Examples of the carrier include: a coated carrier prepared by coating the surface of a core material formed of a magnetic powder with a resin; a magnetic powder-dispersed carrier prepared by dispersing a magnetic powder in a matrix resin; and a resin-impregnated carrier prepared by impregnating a porous magnetic powder with a resin. In each of the magnetic powder-dispersed carrier and the resin-impregnated carrier, the particles forming the carrier may be used as cores, and the surface of the cores may be coated with a resin.

Examples of the magnetic powder include: magnetic metal powders such as iron powder, nickel powder, and cobalt powder; and magnetic oxide powders such as ferrite powder and magnetite powder.

Examples of the coating resin and the matrix resin include polyethylene, polypropylene, polystyrene, polyvinyl acetate, polyvinyl alcohol, polyvinyl butyral, polyvinyl chloride, polyvinyl ethers, polyvinyl ketones, vinyl chloride-vinyl acetate copolymers, styrene-acrylate copolymers, straight silicone resins having organosiloxane bonds and modified products thereof, fluorocarbon resins, polyesters, polycarbonates, phenolic resins, and epoxy resins. The coating resin and the matrix resin may contain an additional additive such as electrically conductive particles. Examples of the electrically conductive particles include: particles of metals such as gold, silver, and copper; and particles of carbon black, titanium oxide, zinc oxide, tin oxide, barium sulfate, aluminum borate, and potassium titanate.

To coat the surface of the core material with a resin, the surface of the core material may be coated with a coating layer-forming solution prepared by dissolving the coating resin and various optional additives in an appropriate solvent. No particular limitation is imposed on the solvent, and the solvent may be selected in consideration of the type of resin used, ease of coating, etc.

Specific examples of the resin coating method include: an immersion method in which the core material is immersed in the coating layer-forming solution; a spray method in which the coating layer-forming solution is sprayed onto the surface of the core material; a fluidized bed method in which the coating layer-forming solution is sprayed onto the core material floated by the flow of air; and a kneader-coater method in which the core material of the carrier and the coating layer-forming solution are mixed in a kneader coater and then the solvent is removed.

The mixing ratio (mass ratio) of the pressure sensitive toner and the carrier in the two-component developer is preferably pressure sensitive toner:carrier=1:100 to 30:100 and more preferably 3:100 to 20:100.

### [Printed Material Production Apparatus and Printed Material Production Method]

The printed material production apparatus using electrophotography includes: a placing device that houses a developer containing the pressure sensitive toner in the present exemplary embodiment and places the pressure sensitive toner on a recording medium by electrophotography; and a pressure-bonding device that folds the recording medium and press-bonds the folded recording medium or that press-bonds the recording medium and an additional recording medium stacked together.

The printed material production apparatus in the present exemplary embodiment performs the printed material production method by electrophotography. The printed material production method in the present exemplary embodiment includes the steps of: placing the pressure sensitive toner in the present exemplary embodiment on a recording medium by electrophotography using a developer containing the pressure sensitive toner; and folding the recording medium and pressure-bonding the folded recording medium or stacking the recording medium and an additional recording medium together and pressure-bonding the stacked recording mediums.

The placing device included in the printed material production apparatus in the present exemplary embodiment includes, for example:

a photoconductor;

charging means for charging the surface of the photoconductor;

electrostatic image forming means for forming an electrostatic image on the charged surface of the photoconductor;

developing means that houses the electrostatic image developer in the present exemplary embodiment and develops the electrostatic image formed on the surface of the photoconductor with the electrostatic image developer to thereby form a pressure sensitive toner-applied portion; and transferring means for transferring the pressure sensitive toner-applied portion formed on the surface of the photoconductor onto the surface of a recording medium.

The placing device may further include fixing means for fixing the pressure sensitive toner-applied portion transferred onto the surface of the recording medium.

The placing step included in the printed material production method in the present exemplary embodiment includes, for example:

a charging step of charging the surface of the photoconductor;

an electrostatic image forming step of forming an electrostatic image on the charged surface of the photoconductor;

a developing step of developing the electrostatic image formed on the surface of the photoconductor with the electrostatic image developer in the present exemplary embodiment to thereby form a pressure sensitive toner-applied portion; and

a transferring step of transferring the pressure sensitive toner-applied portion formed on the surface of the photoconductor onto the surface of a recording medium.

The placing step may further include a fixing step of fixing the pressure sensitive toner-applied portion transferred onto the surface of the recording medium.

Examples of the placing device include: a direct transfer-type device that transfers the pressure sensitive toner-applied portion formed on the surface of the photoconductor directly onto a recording medium; an intermediate transfer-type device that first-transfers the pressure sensitive toner-applied portion formed on the surface of the photoconductor onto the surface of an intermediate transfer body and second-transfers the pressure sensitive toner-applied portion transferred onto the surface of the intermediate transfer body onto the surface of a recording medium; a device including cleaning means for cleaning the surface of the photoconductor after the transfer of the pressure sensitive toner-applied portion but before charging; and a device including charge eliminating means for eliminating charges on the surface of the photoconductor after the transfer of the pressure sensitive toner-applied portion but before charging by irradiating the surface of the photoconductor with charge eliminating light. When the placing device is the intermediate transfer-type device, the transferring means includes, for example: an intermediate transfer body having a surface onto which the pressure sensitive toner-applied portion is to be transferred; first transferring means that first-transfers the pressure sensitive toner-applied portion formed on the surface of the photoconductor onto the surface of the intermediate transfer body; and second transferring means that second-transfers the pressure sensitive toner-applied portion transferred onto the surface of the intermediate transfer body onto the surface of a recording medium.

In the placing device, a portion including the developing means may have a cartridge structure detachably attached to the placing device (the above portion may be a so-called process cartridge). The process cartridge used may be, for example, a process cartridge that houses the electrostatic image developer in the present exemplary embodiment and includes the developing means.

The pressure-bonding device included in the printed material production apparatus in the present exemplary embodiment applies pressure to a recording medium with the pressure sensitive toner in the present exemplary embodiment placed thereon. In this manner, the pressure sensitive toner in the present exemplary embodiment on the recording medium is fluidized and exerts its bonding power. The pressure applied by the pressure-bonding device to the recording medium for the purpose of fluidizing the pressure sensitive toner in the present exemplary embodiment is preferably from 3 MPa to 300 MPa inclusive, more preferably from 10 MPa to 200 MPa inclusive, and still more preferably from 30 MPa to 150 MPa inclusive.

The pressure sensitive toner in the present exemplary embodiment may be placed over the entire recording medium or may be placed on part of the recording medium. A single layer or a plurality of layers of the pressure sensitive toner in the present exemplary embodiment are placed on the recording medium. Each layer of the pressure sensitive toner in the present exemplary embodiment may be a layer extending continuously in in-plane directions of the recording medium or may be a layer extending discontinuously in the in-plane directions of the recording medium. The layer of the pressure sensitive toner in the present exemplary embodiment may be such that the pressure sensitive toner particles themselves are arranged or the pressure sensitive toner particles are arranged with adjacent pressure sensitive toner particles fused together.

The amount of the pressure sensitive toner in the present exemplary embodiment (which may be transparent) on the placement region of the recording medium is, for example, from 0.5 g/m² to 50 g/m² inclusive, from 1 g/m² to 40 g/m² inclusive, and from 1.5 g/m² to 30 g/m² inclusive. The layer thickness of the pressure sensitive toner in the present exemplary embodiment (which may be transparent) on the recording medium is, for example, from 0.2 μm to 25 μm inclusive, from 0.4 μm to 20 μm inclusive, and from 0.6 μm to 15 μm inclusive.

Examples of the recording medium used for the printed material production apparatus in the present exemplary embodiment include paper sheets, coated paper sheets obtained by coating paper sheets with resins etc., fabrics, nonwoven fabrics, resin films, and resin sheets. The recording medium may have an image on one side or both sides.

An example of the printed material production apparatus in the present exemplary embodiment that uses electrophotography will be shown, but the present exemplary embodiment is not limited thereto.

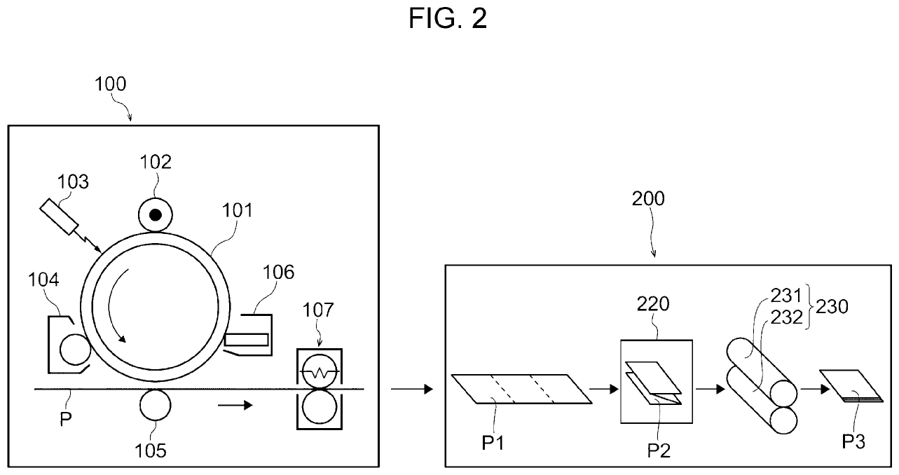

FIG. 2 is a schematic illustration showing an example of the printed material production apparatus in the present exemplary embodiment. The printed material production apparatus shown in FIG. 2 includes a placing device 100 and a pressure-bonding device 200 disposed downstream of the placing device 100. Arrows indicate the rotation direction of a photoconductor or a conveying direction of a recording medium.

The placing device 100 is a direct transfer-type device that places the pressure sensitive toner in the present exemplary embodiment on a recording medium P by electrophotography using a developer containing the pressure sensitive toner in the present exemplary embodiment. The recording medium P has an image formed in advance on one side or both sides.

The placing device 100 includes a photoconductor 101. A charging roller (an example of the charging means) 102, an exposure unit (an example of the electrostatic image forming means) 103, a developing unit (an example of the developing means) 104, a transfer roller (an example of the transferring means) 105, and a photoconductor cleaner (an example of the cleaning means) 106 are disposed around the photoconductor 101 in this order. The charging roller 102 charges the surface of the photoconductor 101, and the exposure unit 103 exposes the charged surface of the photoconductor 101 to a laser beam to form an electrostatic image. The developing unit 104 supplies the pressure sensitive toner to the electrostatic image to develop the electrostatic image, and the transfer roller 105 transfers the developed pressure sensitive toner-applied portion onto the recording medium P. The photoconductor cleaner 106 removes the pressure sensitive toner remaining on the surface of the photoconductor 101 after the transfer.

The operation for placing the pressure sensitive toner in the present exemplary embodiment on the recording medium P using the placing device 100 will be described.

First, the charging roller 102 charges the surface of the photoconductor 101. The exposure unit 103 irradiates the charged surface of the photoconductor 101 with a laser beam according to image data sent from an unillustrated controller. An electrostatic image with the pressure sensitive toner in the present exemplary embodiment arranged in a pattern is thereby formed on the surface of the photoconductor 101.

The electrostatic image formed on the photoconductor 101 rotates to a developing position as the photoconductor 101 rotates. The electrostatic image on the photoconductor 101 is developed at the developing position using the developing unit 104, and a pressure sensitive toner-applied portion is thereby formed.

The developer containing at least the pressure sensitive toner in the present exemplary embodiment and a carrier is housed in the developing unit 104. The pressure sensitive toner in the present exemplary embodiment together with the carrier is agitated in the developing unit 104, thereby frictionally charged, and held on a developer roller. As the surface of the photoconductor 101 passes through the developing unit 104, the pressure sensitive toner electrostatically adheres to the electrostatic image on the surface of the photoconductor 101, and the electrostatic image is developed with the pressure sensitive toner. Then the photoconductor 101 with the pressure sensitive toner-applied portion formed thereon continues running, and the pressure sensitive toner-applied portion formed on the photoconductor 101 is conveyed to a transfer position.

When the pressure sensitive toner-applied portion on the photoconductor 101 is conveyed to the transfer position, a transfer bias is applied to the transfer roller 105, and an electrostatic force directed from the photoconductor 101 toward the transfer roller 105 acts on the pressure sensitive toner-applied portion, so that the pressure sensitive toner-applied portion on the photoconductor 101 is transferred onto the recording medium P.

The pressure sensitive toner remaining on the photoconductor 101 is removed by the photoconductor cleaner 106 and collected. The photoconductor cleaner 106 is, for example, a cleaning blade or a cleaning brush. From the viewpoint of preventing a phenomenon in which the pressure sensitive toner in the present exemplary embodiment remaining on the surface of the photoconductor is fluidized by pressure and adheres to the surface of the photoconductor to form a film, the photoconductor cleaner 106 may be a cleaning brush.

The recording medium P with the pressure sensitive toner-applied portion transferred thereonto is conveyed to the fixing unit (an example of the fixing means) 107. The fixing unit 107 is, for example, a pair of fixing members (roller/roller or belt/roller). The placing device 100 may not include the fixing unit 107. However, from the viewpoint of preventing the pressure sensitive toner in the present exemplary embodiment from falling off the recording medium P, the placing device 100 may include the fixing unit 107. The pressure applied by the fixing unit 107 to the recording medium P may be lower than the pressure applied by the pressurizing unit 230 to the recording medium P2 and may be specifically from 0.2 MPa to 1 MPa inclusive.

The fixing unit 107 may or may not include a built-in heat source (e.g., a halogen heater) for heating the recording medium P. When the fixing unit 107 includes a built-in heat source, the surface temperature of the recording medium P heated by the heat source is preferably from 150° C. to 220° C. inclusive, more preferably from 155° C. to 210° C. inclusive, and still more preferably from 160° C. to 200° C. inclusive. The fixing unit 107 may not include the built-in heat source, but this does not exclude that the temperature inside the fixing unit 107 increases to a temperature equal to or higher than the temperature of the environment due to heat from, for example, a motor included in the placing device 100.

The recording medium P passes through the placing device 100 and thereby becomes a recording medium P1 with the pressure sensitive toner in the present exemplary embodiment placed on the image. The recording medium P1 is conveyed to the pressure-bonding device 200.

In the printed material production apparatus in the present exemplary embodiment, the placing device 100 and the pressure-bonding device 200 may be disposed close to each other or may be spaced apart from each other. When the placing device 100 and the pressure-bonding device 200 are spaced apart from each other, the placing device 100 is connected to the pressure-bonding device 200 through, for example, conveying means (for example, a belt conveyer) for conveying the recording medium P1.

The pressure-bonding device 200 includes a folding unit 220 and a pressurizing unit 230 and is a device that folds and press-bonds the recording medium P1.

The folding unit 220 folds the recording medium P1 passing therethrough to produce a folded recording medium P2. Examples of the mode of folding of the recording medium P2 include a half fold, a trifold, and a quarter fold, and the recording medium may overlap itself only partially. In any of these states, the pressure sensitive toner in the present exemplary embodiment is disposed on at least part of at least one of two opposed surfaces of panels of the folded recording medium P2.

The folding unit 220 may include a pair of pressurizing members (e.g., roller/roller or belt/roller) for applying pressure to the recording medium P2. The pressure applied by the pressurizing members of the folding unit 220 to the recording medium P2 may be smaller than the pressure applied by the pressurizing unit 230 to the recording medium P2 and may be specifically from 1 MPa to 10 MPa inclusive.

The pressure-bonding device 200 may include, instead of the folding unit 220, a stacking unit that stacks the recording medium P1 and an additional recording medium together. Examples of the mode of stacking of the recording medium P1 and the additional recording medium include: a mode in which one additional recording medium is stacked on the recording medium P1; and a mode in which a plurality of additional recording mediums are stacked on respective regions of the recording medium P1. Each additional recording medium may be a recording medium having an image formed in advance on one side or both sides, may be a recording medium having no image formed thereon, or may be a pressure-bonded printed material produced in advance.

The recording medium P2 outputted from the folding unit 220 (or the stacking unit) is conveyed to the pressurizing unit 230.

The pressurizing unit 230 includes, for example, a pair of pressurizing members (i.e., pressurizing rollers 231 and 232). The pressurizing rollers 231 and 232 are in contact with each other at their outer circumferential surfaces, pressed against each other, and apply pressure to the recording medium P2 passing therethrough. The pair of pressurizing members included in the pressurizing unit 230 is not limited to the combination of the pressurizing rollers and may be a combination of a pressurizing roller and a pressurizing belt or a combination of pressurizing belts.

When pressure is applied to the recording medium P2 passing through the pressurizing unit 230, the pressure sensitive toner in the present exemplary embodiment on the recording medium P2 is fluidized by the pressure and exerts its bonding power. The pressure applied by the pressurizing unit 230 to the recording medium P2 is preferably from 3 MPa to 300 MPa inclusive, more preferably from 10 MPa to 200 MPa inclusive, and still more preferably from 30 MPa to 150 MPa inclusive.

The pressurizing unit 230 may or may not include a built-in heat source (e.g., a halogen heater) for heating the recording medium P2. When the pressurizing unit 230 includes a built-in heat source, the surface temperature of the recording medium P2 heated by the heat source is preferably from 30° C. to 120° C. inclusive, more preferably from 40° C. to 100° C. inclusive, and still more preferably from 50° C. to 90° C. inclusive. The pressurizing unit 230 may not include the built-in heat source, but this does not exclude that the temperature inside the pressurizing unit 230 increases to a temperature equal to or higher than the temperature of the environment due to heat from, for example, a motor included in the pressurizing unit 230.

When the recording medium P2 passes through the pressurizing unit 230, the contacting surfaces of the recording medium P2 are bonded through the fluidized pressure sensitive toner in the present exemplary embodiment, and a pressure-bonded printed material P3 is thereby produced. In the pressure-bonded printed material P3, the two opposed surfaces are partly or entirely bonded to each other.

The completed pressure-bonded printed material P3 is discharged from the pressurizing unit 230.

A first form of the pressure-bonded printed material P3 is a pressure-bonded printed material in which the opposed surfaces of panels of the folded recording medium are bonded through the pressure sensitive toner in the present exemplary embodiment. The pressure-bonded printed material P3 in this form is produced using the printed material production apparatus including the folding unit 220.

A second form of the pressure-bonded printed material P3 is a pressure-bonded printed material in which opposed surfaces of a plurality of stacked recording mediums are bonded through the pressure sensitive toner in the present exemplary embodiment. The pressure-bonded printed material P3 in this form is produced using a pressure-bonded printed material production apparatus including the stacking unit.

The printed material production apparatus in the present exemplary embodiment is not limited to a device of the type in which recording mediums P2 are continuously conveyed from the folding unit 220 (or the stacking unit) to the pressurizing unit 230. The printed material production apparatus in the present exemplary embodiment may be a device of the type in which recording mediums P2 discharged from the folding unit 220 (or the stacking unit) are accumulated and then conveyed to the pressurizing unit 230 when the number of accumulated recording mediums P2 reaches a predetermined number.

In the printed material production apparatus in the present exemplary embodiment, the folding unit 220 (or the stacking unit) and the pressurizing unit 230 may be disposed close to each other or may be spaced apart from each other. When the folding unit 220 (or the stacking unit) is spaced apart from the pressurizing unit 230, the folding unit 220 (or the stacking unit) may be connected to the pressurizing unit 230 through, for example, conveying means (e.g., a belt conveyer) for conveying the recording medium P2.

The printed material production apparatus in the present exemplary embodiment may further include cutting means for cutting a recording medium into a predetermined size. Examples of the cutting means include: cutting means that is disposed between the placing device 100 and the pressure-bonding device 200 and cuts off a portion of the recording medium P1 on which the pressure sensitive toner in the present exemplary embodiment is not disposed; cutting means that is disposed between the folding unit 220 and the pressurizing unit 230 and cuts off a portion of the recording medium P2 on which the pressure sensitive toner in the present exemplary embodiment is not disposed; and cutting means that is disposed downstream of the pressure-bonding device 200 and cuts off a portion of the pressure-bonded printed material P3 that is not bonded with the pressure sensitive toner in the present exemplary embodiment.

The printed material production apparatus in the present exemplary embodiment is not limited to a sheet fed-type device. The printed material production apparatus in the present exemplary embodiment may be a device of the type in which a long recording medium is subjected to the placing step and the pressure-bonding step to form a long pressure-bonded printed material and then the long pressure-bonded printed material is cut into a predetermined size.

The printed material production apparatus in the present exemplary embodiment may further include color image forming means for forming a color image on a recording medium by electrophotography using a color electrostatic image developer. The color image forming means includes, for example:

a photoconductor;

charging means for charging the surface of the photoconductor;

electrostatic image forming means for forming an electrostatic image on the charged surface of the photoconductor;

developing means that houses the color electrostatic image developer and develops the electrostatic image formed on the surface of the photoconductor with the color electrostatic image developer to thereby form a color toner image;

transferring means for transferring the color toner image formed on the surface of the photoconductor onto the surface of a recording medium; and

heat-fixing means for heat-fixing the color toner image transferred onto the surface of the recording medium.

The production apparatus having the above-described structure is used to perform the printed material production method in the present exemplary embodiment that further includes a color image forming step of forming a color image by electrophotography on a recording medium using a color electrostatic image developer. Specifically, the color image forming step includes:

a charging step of charging the surface of the photoconductor;

an electrostatic image forming step of forming an electrostatic image on the charged surface of the photoconductor;

a developing step of developing the electrostatic image formed on the surface of the photoconductor with the color electrostatic image developer to thereby form a color toner image;

a transferring step of transferring the color toner image formed on the surface of the photoconductor onto the surface of a recording medium; and

a heat-fixing step of heat-fixing the color toner image transferred onto the surface of the recording medium.

Examples of the color image forming means included in the printed material production apparatus in the present exemplary embodiment include: a direct transfer-type device that transfers the color toner image formed on the surface of the photoconductor directly onto a recording medium; an intermediate transfer-type device that first-transfers the color toner image formed on the surface of the photoconductor onto the surface of an intermediate transfer body and second-transfers the color toner image transferred onto the surface of the intermediate transfer body onto the surface of a recording medium; a device including cleaning means for cleaning the surface of the photoconductor after the transfer of the color toner image but before charging; and a device including charge eliminating means for eliminating charges on the surface of the photoconductor after the transfer of the color toner image but before charging by irradiating the surface of the photoconductor with charge eliminating light. When the color image forming means is the intermediate transfer-type device, the transferring means includes, for example: the intermediate transfer body having a surface onto which the color toner image is to be transferred; first transferring means that first-transfers the color toner image formed on the surface of the photoconductor onto the surface of the intermediate transfer body; and second transferring means that second-transfers the color toner image transferred onto the surface of the intermediate transfer body onto the surface of a recording medium.

In the printed material production apparatus in the present exemplary embodiment, when the placing device that places the developer containing the pressure sensitive toner in the present exemplary embodiment and the color image forming means each use the intermediate transfer method, the placing device and the color image forming means may share the intermediate transfer body and the second transferring means.

In the printed material production apparatus in the present exemplary embodiment, the placing device that places the image developer containing the pressure sensitive toner in the present exemplary embodiment and the color image forming means may share the heat-fixing means.

An example of the printed material production apparatus in the present exemplary embodiment that includes the color image forming means will next be shown, but the present exemplary embodiment is not limited thereto. In the following description, only illustrated portions will be described, and description of other members will be omitted.

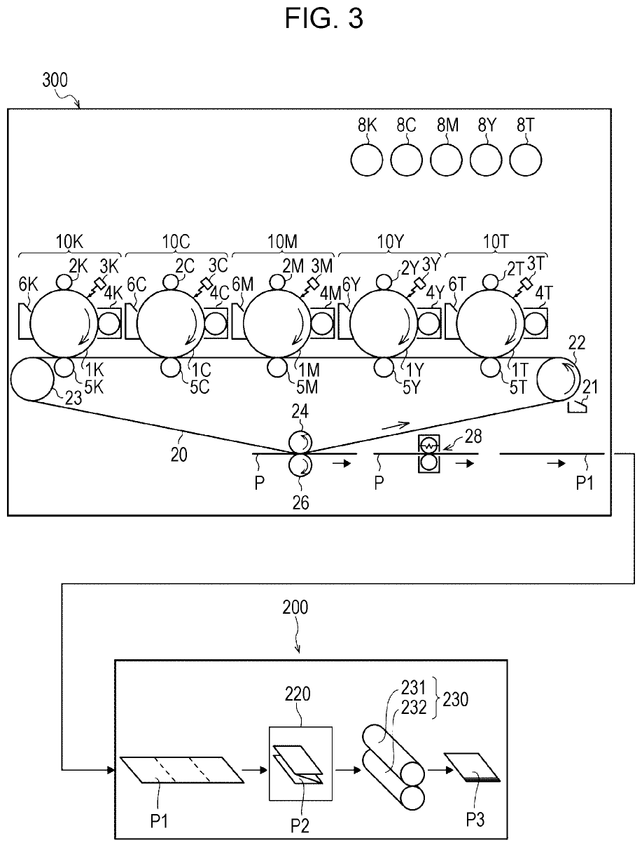

FIG. 3 is a schematic illustration showing an example of the printed material production apparatus in the present exemplary embodiment that uses electrophotography. The printed material production apparatus shown in FIG. 3 includes: printing means 300 that performs the placement of the pressure sensitive toner in the present exemplary embodiment on a recording medium and the formation of a color image on the recording medium in a successive manner; and a pressure-bonding device 200 disposed downstream of the printing means 300.

The printing means 300 is quintuple tandem printing means of the intermediate transfer type. The printing means 300 includes: a unit 10T that places the pressure sensitive toner (T) in the present exemplary embodiment; and units 10Y, 10M, 10C, and 10K that form yellow (Y), magenta (M), cyan (C), and black (K) images, respectively. The unit 10T is the placing device that uses a developer containing the pressure sensitive toner in the present exemplary embodiment to place the pressure sensitive toner in the present exemplary embodiment on a recording medium P. The units 10Y, 10M, 10C, and 10K are each a device that forms a color image on the recording medium P using a developer containing a color toner. The units 10T, 10Y, 10M, 10C, and 10K each use electrophotography.

The units 10T, 10Y, 10M, 10C, and 10K are arranged so as to be horizontally spaced apart from each other. The units 10T, 10Y, 10M, 10C, and 10K each may be a process cartridge detachably attached to the printing means 300.

An intermediate transfer belt (an example of the intermediate transfer body) 20 is disposed so as to extend through lower portions of the units 10T, 10Y, 10M, 10C, and 10K. The intermediate transfer belt 20 is wound around a driving roller 22, a support roller 23, and a facing roller 24 that are in contact with the inner surface of the intermediate transfer belt 20 and runs in a direction from the unit 10T toward the unit 10K. An intermediate transfer body cleaning unit 21 is disposed on the image holding surface side of the intermediate transfer belt 20 so as to be opposed to the driving roller 22.

The units 10T, 10Y, 10M, 10C, and 10K include developing units (examples of the developing means) 4T, 4Y, 4M, 4C, and 4K, respectively. The pressure sensitive toner in the present exemplary embodiment housed in a pressure sensitive toner cartridge 8T and yellow, magenta, cyan, and black toners housed in cartridges 8Y, 8M, 8C, and 8K, respectively, are supplied to the developing units 4T, 4Y, 4M, 4C, and 4K, respectively.

Since the units 10T, 10Y, 10M, 10C, and 10K have the same structure and operate similarly, the unit 10T that places the pressure sensitive toner in the present exemplary embodiment on a recording medium will be described as a representative unit.

The unit 10T includes a photoconductor 1T. A charging roller (an example of the charging means) 2T, an exposure unit (an example of the electrostatic image forming means) 3T, a developing unit (an example of the developing means) 4T, a first transfer roller (an example of the first transferring means) 5T, and a photoconductor cleaner (an example of the cleaning means) 6T are disposed around the photoconductor 1T in this order. The charging roller 2T charges the surface of the photoconductor 1T, and the exposure unit 3T exposes the charged surface of the photoconductor 1T to a laser beam to form an electrostatic image. The developing unit 4T supplies the pressure sensitive toner to the electrostatic image to develop the electrostatic image, and the first transfer roller 5T transfers the developed pressure sensitive toner-applied portion onto the intermediate transfer belt 20. The photoconductor cleaner 6T removes the pressure sensitive toner remaining on the surface of the photoconductor 1T after the first transfer. The first transfer roller 5T is disposed on the inner side of the intermediate transfer belt 20 and placed at a position opposed to the photoconductor 1T.

The operation of the unit 10T will be described as an example, and operations including the placement of the pressure sensitive toner in the present exemplary embodiment on the recording medium P and the formation of a color image on the recording medium P will be described.

First, the charging roller 2T charges the surface of the photoconductor 1T. The exposure unit 3T irradiates the charged surface of the photoconductor 1T with a laser beam according to image data sent from an unillustrated controller. An electrostatic image with the pressure sensitive toner in the present exemplary embodiment arranged in a pattern is thereby formed on the surface of the photoconductor 1T.

The electrostatic image formed on the photoconductor 1T rotates to a developing position as the photoconductor 1T rotates. The electrostatic image on the photoconductor 1T is developed at the developing position using the developing unit 4T, and a pressure sensitive toner-applied portion is thereby formed.

The developer containing at least the pressure sensitive toner in the present exemplary embodiment and a carrier is housed in the developing unit 4T. The pressure sensitive toner in the present exemplary embodiment together with the carrier is agitated in the developing unit 4T, thereby frictionally charged, and held on a developer roller. As the surface of the photoconductor 1T passes through the developing unit 4T, the pressure sensitive toner electrostatically adheres to the electrostatic image on the surface of the photoconductor 1T, and the electrostatic image is developed with the pressure sensitive toner. Then the photoconductor 1T with the pressure sensitive toner-applied portion formed thereon continues running, and the pressure sensitive toner-applied portion formed on the photoconductor 1T is conveyed to a first transfer position.

When the pressure sensitive toner-applied portion on the photoconductor 1T is conveyed to the first transfer position, a first transfer bias is applied to the first transfer roller 5T, and an electrostatic force directed from the photoconductor 1T toward the first transfer roller 5T acts on the pressure sensitive toner-applied portion, so that the pressure sensitive toner-applied portion on the photoconductor 1T is transferred onto the intermediate transfer belt 20. The pressure sensitive toner remaining on the photoconductor 1T is removed by the photoconductor cleaner 6T and collected. The photoconductor cleaner 6T is, for example, a cleaning blade or a cleaning brush and is preferably a cleaning brush.

Similar operations to those in the unit 10T are performed also in each of the unit 10Y, 10M, 10C, and 10K using a developer containing a color toner. The intermediate transfer belt 20 with the pressure sensitive toner-applied portion transferred thereonto in the unit 10T is sequentially transported through the units 10Y, 10M, 10C, and 10K, and toner images of respective colors are multi-transferred onto the intermediate transfer belt 20.

Then the intermediate transfer belt 20 with the pressure sensitive toner-applied portion and the toner images multi-transferred thereonto in the units 10T, 10Y, 10M, 10C, and 10K reaches a second transfer unit that is composed of the intermediate transfer belt 20, the facing roller 24 in contact with the inner surface of the intermediate transfer belt, and a second transfer roller (an example of the second transferring means) 26 disposed on the image holding surface side of the intermediate transfer belt 20. A recording medium P is supplied through a supply mechanism to the gap between the second transfer roller 26 and the intermediate transfer belt 20 in contact with each other, and a second transfer bias is applied to the facing roller 24. In this case, an electrostatic force directed from the intermediate transfer belt 20 to the recording medium P acts on the pressure sensitive toner-applied portion and the toner images, and the pressure sensitive toner-applied portion and the toner images on the intermediate transfer belt 20 are thereby transferred onto the recording medium P.

The recording medium P with the pressure sensitive toner-applied portion and the toner images transferred thereonto is conveyed to a heat-fixing unit (an example of the heat-fixing means) 28. The heat-fixing unit 28 includes a heat source such as a halogen heater and heats the recording medium P. The surface temperature of the recording medium P heated by the heat-fixing unit 28 is preferably from 150° C. to 220° C. inclusive, more preferably from 155° C. to 210° C. inclusive, and still more preferably from 160° C. to 200° C. inclusive. When the recording medium P passes through the heat-fixing unit 28, a color toner image is heat-fixed onto the recording medium P.

From the viewpoint of preventing the pressure sensitive toner in the present exemplary embodiment from falling off the recording medium P and from the viewpoint of improving the fixability of the color image onto the recording medium P, the heat-fixing unit 28 may be a device that performs both heating and pressurization and may be, for example, a pair of fixing members (roller/roller or belt/roller) including a built-in heat source. When the heat-fixing unit 28 performs pressurization, the pressure applied by the heat-fixing unit 28 to the recording medium P may be lower than the pressure applied by the pressurizing unit 230 to the recording medium P2 and may be specifically from 0.2 MPa to 1 MPa inclusive.

When the recording medium P passes through the printing means 300, the recording medium P becomes a recording medium P1 with the color image and the pressure sensitive toner in the present exemplary embodiment applied thereto. The recording medium P1 is conveyed to the pressure-bonding device 200.

The structure of the pressure-bonding device 200 in FIG. 3 may be the same as that of the pressure-bonding device 200 in FIG. 2, and the detailed description of the structure and operation of the pressure-bonding device 200 in FIG. 3 will be omitted.

In the printed material production apparatus in the present exemplary embodiment, the printing means 300 and the pressure-bonding device 200 may be disposed close to each other or may be spaced apart from each other. When the printing means 300 and the pressure-bonding device 200 are spaced apart from each other, the printing means 300 is connected to the pressure-bonding device 200 through, for example, conveying means (e.g., a belt conveyer) for conveying the recording medium P1.

The printed material production apparatus in the present exemplary embodiment may further include cutting means for cutting a recording medium into a predetermined size. Examples of the cutting means include: cutting means that is disposed between the printing means 300 and the pressure-bonding device 200 and cuts off a portion of the recording medium P1 on which the pressure sensitive toner in the present exemplary embodiment is not disposed; cutting means that is disposed between the folding unit 220 and the pressurizing unit 230 and cuts off a portion of the recording medium P2 on which the pressure sensitive toner in the present exemplary embodiment is not disposed; and cutting means that is disposed downstream of the pressure-bonding device 200 and cuts off a portion of the pressure-bonded printed material P3 that is not bonded with the pressure sensitive toner in the present exemplary embodiment.

The printed material production apparatus in the present exemplary embodiment is not limited to a sheet fed-type device. The printed material production apparatus in the present exemplary embodiment may be a device of the type in which a long recording medium is subjected to the color image forming step, the placing step, and the pressure-bonding step to form a long pressure-bonded printed material and then the long pressure-bonded printed material is cut into a predetermined size.

### [Process Cartridge]

A process cartridge used for the printed material production apparatus using electrophotography will be described.

The process cartridge in the present exemplary embodiment houses the electrostatic image developer in the present exemplary embodiment and includes developing means for developing an electrostatic image formed on the surface of a photoconductor with the electrostatic image developer to thereby form a pressure sensitive toner-applied portion. The process cartridge is detachably attached to the printed material production apparatus.

The process cartridge in the present exemplary embodiment includes the developing means and optionally includes at least one selected from a photoconductor, charging means, electrostatic image forming means, transferring means, etc.

An example of the process cartridge in the present exemplary embodiment is a cartridge in which a photoconductor is integrated, within a housing, with a charging roller (an example of the charging means), a developing unit (an example of the developing means), and a photoconductor cleaner (an example of the cleaning means) that are disposed around the photoconductor. The housing has an opening for exposure to light. The housing includes mounting rails, and the process cartridge is attached to the printed material production apparatus using the mounting rails.

The image forming apparatus shown in FIG. 3 includes the toner cartridges 8Y, 8M, 8C, and 8K that are detachably attached to the image forming apparatus, and the developing units 4Y, 4M, 4C, and 4K are connected to the respective toner cartridges corresponding to the respective developing units (colors) through unillustrated toner supply tubes. When the amount of the toner housed in a toner cartridge is reduced, this toner cartridge is replaced.

### EXAMPLES

Examples will next be described. However, the present disclosure is not limited to the following Examples. In the following description, “parts” and “%” are based on mass, unless otherwise specified.

### Example 1

### (First Step: Preparation of Styrene-Based Resin Particle Dispersion)

Styrene (as a polymerization component): 370 parts
n-Butyl acrylate (as a polymerization component): 115 parts
Acrylic acid (as a polymerization component): 15 parts
Dodecanethiol (as a chain transfer agent): 7.5 parts

The above materials are mixed and dissolved to prepare a monomer solution (1).

8 Parts of an anionic surfactant (DOWFAX 2A1 manufactured by Dow Chemical Company) is dissolved in 205 parts of ion exchanged water, and the monomer solution (1) is added thereto and dispersed to thereby obtain an emulsion.

1.8 Parts of the anionic surfactant was dissolved in 462 parts of ion exchanged water, and the mixture is placed in a polymerization flask equipped with a stirrer, a thermometer, a reflux condenser tube, and a nitrogen gas introduction tube, heated to 73° C. under stirring, and held. 3 Parts of ammonium persulfate is dissolved in 21 parts of ion exchanged water. The mixture is added dropwise to the polymerization flask over 15 minutes using a metering pump, and the emulsion is added dropwise to the polymerization flask over 160 minutes using a metering pump. Then the polymerization flask is held at 75° C. for 3 hours under gentle stirring and then returned to room temperature.

A styrene-based resin particle dispersion (St1) with a solid content of 42% is thereby obtained. The styrene-based resin particles have a volume average particle diameter (D50v) of 198 nm, and the styrene-based resin has a weight average molecular weight of 45,000 as determined by GPC (UV detection) and a glass transition temperature of 53° C.

### (Second Step: Preparation of Pressure Sensitive Toner)

Styrene-based resin particle dispersion (St1): 980 parts
n-Butyl acrylate (as a polymerization component): 200 parts
2-Ethylhexyl acrylate (as a polymerization component): 150 parts
Dodecanethiol (as a chain transfer agent): 4.3 parts
1,10-Decanediol diacrylate (as a crosslinking agent, A-DOD-N manufactured by Shin Nakamura Chemical Co., Ltd.): 2.2 parts
Ion exchanged water: 1,200 parts

The above materials are placed in a polymerization flask to prepare a monomer solution (2). The monomer solution (2) is stirred at 25° C. for 1 hour and then heated to 70° C. 2.5 Parts of ammonium persulfate is dissolved in 75 parts of ion exchanged water, and the mixture is added dropwise to the polymerization flask over 60 minutes using a metering pump. Next, while the mixture is slowly stirred, the polymerization flask is held at 70° C. for 3 hours. 85 Parts of styrene and 15 parts of n-butyl acrylate used as polymerization components are mixed and dissolved to prepare a monomer solution (3), and the monomer solution (3) is added dropwise to the polymerization flask over 30 minutes. 2.5 Parts of ammonium persulfate is dissolved in 75 parts of ion exchanged water, and the mixture is added dropwise to the polymerization flask over 60 minutes using a metering pump. After completion of the dropwise addition, the mixture is held at 75° C. for 3 hours and returned to room temperature. A composite resin particle dispersion with a solid content of 33% is thereby obtained. The composite resin particles have a volume average particle diameter (D50v) of 265 nm, and the composite resin has a weight average molecular weight of 250000 as determined by GPC (UV detection).

### (Preparation of Release Agent Particle Dispersion)

Polyalkylene wax (FNP0100 manufactured by Nippon Seiro Co., Ltd., melting point: 100° C.): 45 parts by mass
Anionic surfactant (Neogen RK manufactured by DAI-ICHI KOGYO SEIYAKU Co., Ltd.): 5 parts by mass
Ion exchanged water: 200 parts by mass

The above components are heated to 110° C., dispersed sufficiently using ULTRA-TURRAX T50 manufactured by IKA, and subjected to dispersion treatment using a pressure ejection-type Gaulin homogenizer to thereby obtain a release agent particle dispersion with a solid content of 18%. The release agent particles have a median diameter of 220 nm.

### (Preparation of Toner)

Composite resin particle dispersion: 504 parts
Ion exchanged water: 710 parts
Release agent particle dispersion: 10 parts
Anionic surfactant (DOWFAX 2A1 manufactured by Dow Chemical Company): 1 part

The above materials are placed in a reaction vessel equipped with a thermometer and a pH meter, and a 1.0% aqueous nitric acid solution is added at a temperature of 25° C. to adjust the pH to 3,0. Then, while the mixture is dispersed at 5,000 rpm using a homogenizer (ULTRA-TURRAX T50 manufactured by IKA Japan), 23 parts of a 2.0% aqueous aluminum sulfate solution is added. Next, a stirrer and a heating mantle are attached to the reaction vessel. While the temperature of the mixture is increased at a heating rate of 0.5° C./minute until the temperature reaches 50° C. and then at a heating rate of 0.05° C./minute after the temperature has exceeded 50° C., the particle diameters are measured at 10 minute intervals using Multisizer II (manufactured by Beckman Coulter, Inc., aperture diameter: 50 μm). When the volume average particle diameter reaches 8.7 μm, the temperature is held constant, and 170 parts of the styrene-based resin particle dispersion (St1) is added over 5 minutes. After completion of the addition, the slurry is held at 50° C. for 30 minutes, and a 1.0% aqueous sodium hydroxide solution is used to adjust the pH of the slurry to 6.0. Then the temperature is increased to 94° C. at a heating rate of 1° C./minute while the pH is adjusted to 6.0 at 5° C. intervals, and the slurry is held at 94° C. for 4 hours. An optical microscope and a field emission scanning electron microscope (FE-SEM) are used to observe the shapes of the particles and their surface properties. Since coalescence of the particles is found, the container is cooled using cooling water to 30° C. over 5 minutes.

The cooled slurry is allowed to pass through a nylon mesh with a mesh size of 20 μm to remove coarse particles, and the slurry passing through the mesh is filtered using an aspirator under reduced pressure. The solids remaining on the paper filter are added to ion exchanged water (temperature: 30° C., 30 times the mass of the solids), and the mixture is stirred for 30 minutes. The resulting mixture is filtered using an aspirator under reduced pressure, and the solids remaining on the paper filter are vacuum-dried in an oven at 25° C. for 48 hours to thereby obtain toner particles. The toner particles have a volume average particle diameter of 9.0 μm.

100 Parts of the toner particles and 1.5 parts of hydrophobic silica (RY50 manufactured by Nippon Aerosil Co., Ltd.) are mixed and stirred using a sample mill at a rotation speed of 13,000 rpm for 30 seconds. The mixture is sieved using a vibrating sieve with a mesh size of 45 μm to obtain a pressure sensitive toner.

### (Production of Electrostatic Image Developer)

10 Parts of the pressure sensitive toner and 100 parts of the following resin-coated carrier (1) are placed in a V blender, stirred for 20 minutes, and sieved using a vibrating sieve with a mesh size of 212 μm to obtain an electrostatic image developer.

### Resin-Coated Carrier (1)

Mn—Mg—Sr-based ferrite particles (average particle diameter: 40 μm): 100 parts
Toluene: 14 parts
Polymethyl methacrylate: 2 parts
Carbon black (VXC72 manufactured by Cabot Corporation): 0.12 parts

The above materials except for the ferrite particles and glass beads (diameter: 1 mm, the same amount as the amount of toluene) are mixed and stirred at a rotation speed of 1200 rpm for 30 minutes using a sand mill manufactured by Kansai Paint Co., Ltd. to obtain a dispersion. The dispersion and the ferrite particles are placed in a vacuum degassed-type kneader and dried under reduced pressure while stirred to thereby obtain a resin-coated carrier (1).

### Examples 2 to 11 and Comparative Examples 1 and 2

Pressure sensitive toners and electrostatic image developers are obtained using the same procedure as in Example 1 except that the type of styrene-based resin, the type of (meth)acrylate-based resin, the mass ratio of the styrene-based resin to the (meth)acrylate-based resin (the mass ratio St/Ac), the type and amount of chain transfer agent used, the type and amount of crosslinking agent used, the mass ratio of the crosslinking agent to the chain transfer agent (the crosslinking agent/the chain transfer agent), the type of release agent, and the amount of the flocculant used are changed as shown in Table 1.

### <Evaluation of Pressure Sensitive Toners>

### (Evaluation of Bonding Power)

Letter images are printed on a C2 paper sheet (manufactured by FUJIFILM Business Innovation Corp., basis weight: 82 gsm) using an electrophotographic printer, and the paper sheet is cut into the size of a V-folded postcard. One of the obtained pressure sensitive toners is applied over the entire cut paper sheet using a bar coater in an application amount of 2.5 g/m². The pressure sensitive toner is fixed onto the sheet and dried using a fixing bench of a multi-function device and then folded in half. The folded sheet is caused to pass through a sealer (Pressle multi 2 manufactured by TOPPAN FORMS CO., LTD.) to apply a pressure (Gap10, pressure: 90 MPa). The resulting folded sheet is left to stand overnight and cut into a width of 15 mm, and the cut sheet is used as a test piece and subjected to a 90 degree peel test.

The peeling rate in the 90 degree peel test is 20 mm/minute. The load (N) is measured at 0.4 mm intervals when the tensile distance of the sample is in the range of 10 mm to 50 mm after the start of the measurement, and the average of the measured values is computed. The load (N) required for peeling is rated as follows to evaluate the bonding strength. The evaluation rating C indicates that the bonding strength is insufficient and the target value is not obtained. The evaluation results are shown in Table 1.
A: 0.8 N or more
B: 0.4 N or more and less than 0.8 N
C: less than 0.4 N

### (Evaluation of Tear Resistance of Sheet (Tear Resistance During Peeling))

A paper sheet subjected to pressure applied using the sealer in the same manner as in the evaluation of the bonding strength is stored in a chamber at 30° C. and 90% RH for one week. Then the bonded portion is peeled by hand, and a tear of the sheet is rated using the following evaluation criteria. The evaluation results are shown in Table 1.
A: No tear is found.
B: A slight tear is found in the sheet (no problem in the image).
C: A large tear is found in the sheet (the tear reaches the image portion).

### (Evaluation of Hot Offset Resistance)

An apparatus obtained by modifying DocuCentre C7550 (manufactured by FUJIFILM Business Innovation Corp.) is used to produce a 4 cm×4 cm image with a toner amount of 15.0 g/m² on a C2 paper sheet. The image is fixed using a fixing device modified such that the process speed is fixed at 600 mm/sec and the fixing temperature is fixed at 190° C. or 230° C. The image is printed on 10 sheets and rated using the following evaluation criteria. The evaluation results are shown in Table 1.
A: No hot offset is found at fixing temperatures of 190° C. and 230° C.
B: Hot offset is found in three or less sheets at a fixing temperature of 230° C., and no hot offset is found at a fixing temperature of 190° C.
C: Hot offset is found in four or more sheets at a fixing temperature of 230° C., or hot offset is found in at least one sheet at a fixing temperature of 190° C.

TABLE 1

| | Toner particles | | | | | | | | |
|---|---|---|---|---|---|---|---|---|---|
| | Composite resin | | | | | | | | |
| | | | | Amount of | | | | | |
| | | | | chain | | | Mass ratio | | |
| | | | | transfer | | Amount of | of | | Gel |
| | Types of | Mass | | agent | | crosslinking | crosslinking | | fraction of |
| | styrene-based | ratio | | used | Type of | agent used | agent/chain | Mw of | composite |
| | resin | of | Type of chain | (parts by | crosslinking | (parts by | transfer | composite | resin |
| | components | St/Ac | transfer agent | mass) | agent | mass) | agent | resin | X (%) |
| Example 1 | St/BA/AA | 60/40 | Dodecanethiol | 0.5 | A-DOD-N | 0.25 | 0.5 | 25 × 10⁴ | 0.9 |
| Example 2 | St/BA/AA | 60/40 | Dodecanethiol | 0.3 | A-DOD-N | 0.3 | 1.0 | 40 × 10⁴ | 1.9 |
| Example 3 | St/BA/AA | 60/40 | Dodecanethiol | 1.0 | A-DOD-N | 0.1 | 0.1 | 8 × 10⁴ | 0.1 |
| Example 4 | St/BA/AA | 60/40 | Dodecanethiol | 1.0 | A-DOD-N | 0.1 | 0.1 | 8 × 10⁴ | 0.1 |
| Example 5 | St/BA/AA | 60/40 | Dodecanethiol | 0.5 | A-DOD-N | 0.25 | 0.5 | 25 × 10⁴ | 0.9 |
| Example 6 | St/BA/AA | 40/60 | Dodecanethiol | 0.5 | A-DOD-N | 0.25 | 0.5 | 18 × 10⁴ | 0.6 |
| Example 7 | St/BA/AA | 60/40 | Dodecanethiol | 0.5 | Ethylene | 0.25 | 0.5 | 28 × 10⁴ | 1.2 |
| | | | | | glycol | | | | |
| | | | | | diacrylate | | | | |
| Example 8 | St/BA/AA | 60/40 | Decanethiol | 0.5 | A-DOD-N | 0.25 | 0.5 | 24 × 10⁴ | 0.8 |
| Example 9 | St/BA/MAA | 60/40 | Dodecanethiol | 0.5 | A-DOD-N | 0.25 | 0.5 | 25 × 10⁴ | 0.9 |
| Example 10 | St/BA/AA | 60/40 | Dodecanethiol | 0.5 | A-DOD-N | 0.25 | 0.5 | 25 × 10⁴ | 0.9 |
| Example 11 | St/BA/AA | 60/40 | Dodecanethiol | 0.5 | A-DOD-N | 0.25 | 0.5 | 25 × 10⁴ | 0.9 |
| Comparative | St/BA/AA | 60/40 | Dodecanethiol | 0.25 | A-DOD-N | 0.3 | 1.2 | 55 × 10⁴ | 2.5 |
| Example 1 | | | | | | | | | |
| Comparative | St/BA/AA | 60/40 | Dodecanethiol | 2.0 | A-DOD-N | 0.1 | 0.05 | 3 × 10⁴ | 0 |
| Example 2 | | | | | | | | | |

| | Toner particles | | | | | | | |
|---|---|---|---|---|---|---|---|---|
| | | | Amount | | | | | |
| | Volume | | of | Gel | | Evaluation results | | |
| | average | | flocculant | fraction | | | Tear | |
| | particle | | used | of toner | | | resistance | |
| | diameter | | (parts by | particles | Value | Bonding | during | Hot offset |
| | (μm) | Type of release agent | mass) | Y (%) | of Y/X | power | peeling | resistance |
| Example 1 | 9.0 | FNP0100 | 3 | 3.2 | 3.6 | A | A | A |
| | | (melting point: 100° C.) | | | | | | |
| Example 2 | 9.0 | FNP0100 | 3 | 7.0 | 3.7 | A | B | A |
| | | (melting point: 100° C.) | | | | | | |
| Example 3 | 9.0 | FNP0100 | 3 | 1.0 | 10.0 | A | A | B |
| | | (melting point: 100° C.) | | | | | | |
| Example 4 | 9.0 | FNP0100 | 4.5 | 8.0 | 80.0 | A | B | A |
| | | (melting point: 100° C.) | | | | | | |
| Example 5 | 9.0 | FNP0100 | 2 | 1.3 | 1.4 | A | A | B |
| | | (melting point: 100° C.) | | | | | | |
| Example 6 | 9.0 | FNP0100 | 3 | 3.0 | 5.0 | A | A | A |
| | | (melting point: 100° C.) | | | | | | |
| Example 7 | 9.0 | FNP0100 | 3 | 3.5 | 2.9 | A | A | A |
| | | (melting point: 100° C.) | | | | | | |
| Example 8 | 9.0 | FNP0100 | 3 | 3.1 | 3.9 | A | A | A |
| | | (melting point: 100° C.) | | | | | | |
| Example 9 | 9.0 | FNP0100 | 3 | 3.2 | 3.6 | A | A | A |
| | | (melting point: 100° C.) | | | | | | |
| Example 10 | 9.0 | FNP0085 | 3 | 3.8 | 4.2 | A | A | A |
| | | (melting point: 85° C.) | | | | | | |
| Example 11 | 7.0 | FNP0100 | 3 | 2.9 | 3.2 | A | A | A |
| | | (melting point: 100° C.) | | | | | | |
| Comparative | 9.0 | FNP0100 | 3 | 10.0 | 4.0 | A | C | A |
| Example 1 | | (melting point: 100° C.) | | | | | | |
| Comparative | 9.0 | FNP0100 | 3 | 0.2 | — | C | A | C |
| Example 2 | | (melting point: 100° C.) | | | | | | |

In Table 1, St in the column of the type of styrene-based resin components stands for styrene, BA stands for n-butyl acrylate. AA stands for acrylic acid, and MAA stands for methacrylic acid. The “mass ratio of St/Ac” in Table 1 is the mass ratio of the styrene-based resin to the (meth)acrylate-based resin. FNP0085 (melting point: 85° C.) in Table 1 represents polyalkylene wax (manufactured by Nippon Seiro Co., Ltd.).

As can be seen from the above results, the bonding power, tear resistance during peeling, and hot offset resistance in the Examples are better than those in the Comparative Examples.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A pressure sensitive toner comprising:
toner particles containing a composite resin that includes a styrene-based resin and a (meth)acrylate-based resin,
wherein the difference between a lowest glass transition temperature of the composite resin and a highest glass transition temperature thereof is 30° C. or more, and
wherein the toner particles have a gel fraction of from 1.0% by mass to 8.0% by mass inclusive.

2. The pressure sensitive toner according to claim 1, wherein the pressure sensitive toner has a melt viscosity at 100° C. of from 4,000 Pa·s to 20,000 Pa·s inclusive.

3. The pressure sensitive toner according to claim 1, wherein the toner particles are fused-coalesced particles containing at least particles of the composite resin.

4. The pressure sensitive toner according to claim 1, wherein the mass ratio of the styrene-based resin to the (meth)acrylate-based resin in the composite resin is 20:80 to 80:20.

5. The pressure sensitive toner according to claim 1, wherein the ratio Y/X of the gel fraction Y of the toner particles to the gel fraction X of the composite resin satisfies 0.8≤Y/X≤80.

6. The pressure sensitive toner according to claim 1, wherein the composite resin has a weight average molecular weight of from 50000 to 500000 inclusive.

7. The pressure sensitive toner according to claim 6, wherein the weight average molecular weight of the composite resin is from 100000 to 350000 inclusive.

8. The pressure sensitive toner according to claim 1, wherein the composite resin is a resin having a crosslinked structure.

9. The pressure sensitive toner according to claim 8, wherein the (meth)acrylate-based resin has the crosslinked structure.

10. The pressure sensitive toner according to claim 1, wherein a content of the composite resin in the toner particles is from 65% by mass to 90% by mass inclusive based on a total mass of the toner particles.

11. The pressure sensitive toner according to claim 1, wherein the toner particles have a volume average particle diameter of from 4 μm to 12 μm inclusive.

12. The pressure sensitive toner according to claim 1, wherein the composite resin has a gel fraction of from 0.1% by mass to 2% by mass inclusive.

13. An apparatus for producing a printed material, the apparatus comprising:
a placing device that houses the pressure sensitive toner according to claim 1 and places the pressure sensitive toner on a recording medium; and
a pressure-bonding device that folds the recording medium and press-bonds the folded recording medium or that press-bonds the recording medium and an additional recording medium stacked together.

14. A method for producing a printed material, the method comprising:
placing the pressure sensitive toner according to claim 1 on a recording medium; and
folding the recording medium and pressure-bonding the folded recording medium or stacking the recording medium and an additional recording medium together and pressure-bonding the stacked recording mediums.

15. A printed material comprising a folded recording medium,
wherein opposed surfaces of panels of the folded recording medium are bonded with the pressure sensitive toner according to claim 1.

16. A printed material comprising a plurality of stacked recording mediums,
wherein opposed surfaces of the stacked recording mediums are bonded with the pressure sensitive toner according to claim 1.
